(19) United States
(12) Patent Application Publication
(10) Pub. No.: US 2025/0289682 A1
(43) Pub. Date: Sep. 18, 2025

(54) POST-PROCESSING APPARATUS AND IMAGE FORMING APPARATUS

(71) Applicants: Naofumi YOSHIDA, Kanagawa (JP); Yuusuke SHIBASAKI, Kanagawa (JP); Yusuke HIRONO, Kanagawa (JP); Atsushi SHINODA, Kanagawa (JP); Shuuto TOHKAISHI, Kanagawa (JP); Sho ASANO, Kanagawa (JP); Wataru TAKAHASHI, Kanagawa (JP); Tomomichi HOSHINO, Kanagawa (JP); Kotomi KAMEYAMA, Kanagawa (JP); Satoshi HIRATA, Kanagawa (JP); Shingo YOSHIZAWA, Kanagawa (JP); Suzuka FUJITA, Kanagawa (JP); Hirotaka YASUKAWA, Kanagawa (JP); Yoshito SUZUKI, Kanagawa (JP); Shinya MONMA, Kanagawa (JP); Ryota TAKAYAMA, Kanagawa (JP); Takahiro WATANABE, Kanagawa (JP); Yuji SUZUKI, Kanagawa (JP); Wataru NOZAKI, Kanagawa (JP); Jun YAMADA, Kanagawa (JP); Yohsuke HARAGUCHI, Kanagawa (JP); Naohiro YOSHIDA, Kanagawa (JP)

(72) Inventors: Naofumi YOSHIDA, Kanagawa (JP); Yuusuke SHIBASAKI, Kanagawa (JP); Yusuke HIRONO, Kanagawa (JP); Atsushi SHINODA, Kanagawa (JP); Shuuto TOHKAISHI, Kanagawa (JP); Sho ASANO, Kanagawa (JP); Wataru TAKAHASHI, Kanagawa (JP); Tomomichi HOSHINO, Kanagawa (JP); Kotomi KAMEYAMA, Kanagawa (JP); Satoshi HIRATA, Kanagawa (JP); Shingo YOSHIZAWA, Kanagawa (JP); Suzuka FUJITA, Kanagawa (JP); Hirotaka YASUKAWA, Kanagawa (JP); Yoshito SUZUKI, Kanagawa (JP); Shinya MONMA, Kanagawa (JP); Ryota TAKAYAMA, Kanagawa (JP); Takahiro WATANABE, Kanagawa (JP); Yuji SUZUKI, Kanagawa (JP); Wataru NOZAKI, Kanagawa (JP); Jun YAMADA, Kanagawa (JP); Yohsuke HARAGUCHI, Kanagawa (JP); Naohiro YOSHIDA, Kanagawa (JP)

(73) Assignee: Ricoh Company, Ltd., Ohta-ku, Tokyo (JP)

(21) Appl. No.: 19/076,624

(22) Filed: Mar. 11, 2025

(30) Foreign Application Priority Data
Mar. 13, 2024 (JP) 2024-038757

(51) Int. Cl. B65H 43/04; B65H 37/04; G03G 15/00

(52) U.S. Cl. CPC B65H 43/04; B65H 37/04; G03G 15/6544; B65H 2301/51611; B65H 2551/21; B65H 2553/30; B65H 2801/27; G03G 2215/00827

(57) ABSTRACT

A post-processing apparatus includes a post-processing device, a sound collector, and circuitry. The post-processing device performs a post-processing operation on a sheet. The sound collector collects and inputs an operating sound of the post-processing operation performed by the post-processing device. The circuitry is to determine whether the operating sound input from the sound collector is normal or abnormal, output an error notification that the post-processing operation is abnormal when the operating sound is determined to be abnormal, and control the post-processing device to end the post-processing operation when the operating sound is determined to be normal.

### CROSS-REFERENCE TO RELATED APPLICATION

This patent application is based on and claims priority pursuant to 35 U.S.C. § 119 (a) to Japanese Patent Application No. 2024-038757, filed on Mar. 13, 2024, in the Japan Patent Office, the entire disclosure of which is hereby incorporated by reference herein.

### BACKGROUND

### Technical Field

Embodiments of the present disclosure relate to a post-processing apparatus and an image forming apparatus.

### Background Art

Typical post-processing apparatus are known that perform a sheet binding operation by a manual operation on sheets manually inserted.

As an apparatus that performs such a sheet binding operation, in order to occurrence of an operation against the intension of the user in execution of the sheet binding operation by an input of the sound, a post-processing apparatus discloses that determines whether to inquire of a user according to the combination of the specified value of the setting item, when there is a setting item to which a sound is not input.

### SUMMARY

Embodiments of the present disclosure described herein provide a novel post-processing apparatus including a post-processing device, a sound collector, and circuitry. The post-processing device performs a post-processing operation on a sheet. The sound collector collects and inputs an operating sound of the post-processing operation performed by the post-processing device. The circuitry is to determine whether the operating sound input from the sound collector is normal or abnormal, output an error notification that the post-processing operation is abnormal when the operating sound is determined to be abnormal, and control the post-processing device to end the post-processing operation when the operating sound is determined to be normal.

Further, embodiments of the present disclosure described herein provide an image forming apparatus including an image forming device to form an image on a sheet, and the above-described post-processing apparatus.

Further, embodiments of the present disclosure described herein provide an image forming apparatus including an image forming device, a post-processing apparatus, a sound collector, and circuitry. The image forming device forms an image on a sheet. The post-processing apparatus performs a post-processing operation on the sheet that has passed through the image forming device. The sound collector collects and inputs an operating sound of the post-processing operation performed by the post-processing apparatus. The circuitry is to determine whether the operating sound input by the sound collector is normal or abnormal, output an error notification that the post-processing operation is abnormal when the operating sound is determined to be abnormal, and control the post-processing device to end the post-processing operation when the operating sound is determined to be normal.

### BRIEF DESCRIPTION OF THE SEVERAL VIEWS OF THE DRAWINGS

Exemplary embodiments of this disclosure will be described in detail based on the following figures, wherein:

FIG. 1 is a diagram illustrating a schematic side view of an example of the overall configuration of an image forming apparatus according to a first embodiment of the present disclosure;

FIG. 2A is a diagram illustrating an example of a functional block of an image forming apparatus according to the first embodiment;

FIG. 2B is a diagram illustrating an example of a structure of the image forming apparatus of FIG. 2A;

FIG. 3 is a diagram illustrating a schematic side view of another example of the overall configuration of an image forming apparatus according to the first embodiment of the present disclosure;

FIG. 4A is a diagram illustrating another example of a functional block of an image forming apparatus according to the first embodiment;

FIG. 4B is a diagram illustrating another example of a structure of the image forming apparatus of FIG. 4A;

FIGS. 5A and 5B are diagrams illustrating a configuration of an inner finisher included in an image forming apparatus according to the first embodiment of the present disclosure;

FIG. 6 is a block diagram illustrating an example of a hardware configuration of an image forming apparatus according to the first embodiment of the present disclosure;

FIG. 7 is a flowchart of an example of a process for executing a manual binding operation of an inner finisher included in an image forming apparatus according to the first embodiment of the present disclosure;

FIGS. 8A, 8B and 8C are diagrams each of which illustrates a waveform of sound when a stapler performs a sheet binding operation;

FIG. 9 is a diagram illustrating a case where a sheet binding operation is performed when a sheet bundle is not correctly set in an image forming apparatus according to the first embodiment of the present disclosure;

FIG. 10 is a diagram illustrating an example of a screen that is displayed when a sheet binding operation is performed when a sheet bundle is not correctly set in an image forming apparatus according to the first embodiment of the present disclosure;

FIGS. 11A, 11B and 11C are diagrams each of which illustrates a case where a sheet binding operation is performed when a sheet bundle that exceeds the maximum number of sheets to be bound is set in an image forming apparatus according to the first embodiment of the present disclosure;

FIG. 12 is a diagram illustrating an example of a screen that is displayed when a sheet binding operation is performed when a sheet bundle that exceeds the maximum number of sheets to be bound is set in an image forming apparatus according to the first embodiment of the present disclosure;

FIGS. 13A and 13B are diagrams each of which illustrates a case where a sheet binding operation is performed when a sheet bundle that exceeds the maximum number of sheets to be bound in an image forming apparatus according to the first embodiment of the present disclosure;

FIGS. 14A and 14B are diagrams illustrating a configuration of an inner finisher included in an image forming apparatus according to a second embodiment of the present disclosure;

FIG. 15 is a block diagram illustrating an example of a hardware configuration of an image forming apparatus according to the second embodiment of the present disclosure;

FIG. 16 is a flowchart of an example of a process for executing a manual binding operation of an inner finisher included in an image forming apparatus according to the second embodiment of the present disclosure;

FIGS. 17A and 17B are diagrams illustrating a configuration of an inner finisher included in an image forming apparatus according to a third embodiment of the present disclosure;

FIGS. 18A and 18B are diagrams each of which illustrates an operation of an inner finisher included in an image forming apparatus according to the third embodiment of the present disclosure;

FIG. 19 is a block diagram illustrating an example of a hardware configuration of an image forming apparatus according to the third embodiment of the present disclosure;

FIG. 20 including FIGS. 20A and 20B is a flowchart of an example of a process for executing a manual binding operation of an inner finisher included in an image forming apparatus according to the third embodiment of the present disclosure;

FIG. 21 is a diagram illustrating an operation of an inner finisher included in an image forming apparatus according to a modification of the third embodiment of the present disclosure;

FIG. 22 including FIGS. 22A and 22B is a flowchart of an example of a process for executing a manual binding operation of an inner finisher included in an image forming apparatus according to the modification of the third embodiment of the present disclosure;

FIGS. 23A and 23B are diagrams illustrating a configuration of an inner finisher included in an image forming apparatus according to a four embodiment of the present disclosure;

FIGS. 24A and 24B are diagrams each of which illustrates an operation of an inner finisher included in an image forming apparatus according to the fourth embodiment of the present disclosure;

FIG. 25 is a block diagram illustrating an example of a hardware configuration of an image forming apparatus according to the fourth embodiment of the present disclosure;

FIG. 26 including FIGS. 26A and 26B is a flowchart of an example of a process for executing a manual binding operation of an inner finisher included in an image forming apparatus according to the fourth embodiment of the present disclosure;

FIG. 27 is a diagram illustrating an operation of an inner finisher included in an image forming apparatus according to the fourth embodiment of the present disclosure; and

FIG. 28 including FIGS. 28A and 28B is a flowchart of an example of a process for executing a manual binding operation of an inner finisher included in an image forming apparatus according to the fourth embodiment of the present disclosure.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. As used herein, the term “connected/coupled” includes both direct connections and connections in which there are one or more intermediate connecting elements. Like numbers refer to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Embodiments of the present disclosure are described below in detail with reference to the drawings. Like reference signs are assigned to identical or equivalent components and a description of those components may be simplified or omitted.

Hereinafter, a post-processing apparatus and an image forming apparatus according to embodiments of the present disclosure are described in detail with reference to drawings. The present disclosure, however, is not limited to the following one or more embodiments, and elements of the following one or more embodiments include elements that may be easily conceived by those skilled in the art, those being substantially the same ones, and those being within equivalent ranges. Various omissions, substitutions, changes, and combinations of constituent elements can be made without departing from the gist of the following embodiments.

### First Embodiment

### Overall Configuration and Block Diagrams of Image Forming Apparatus

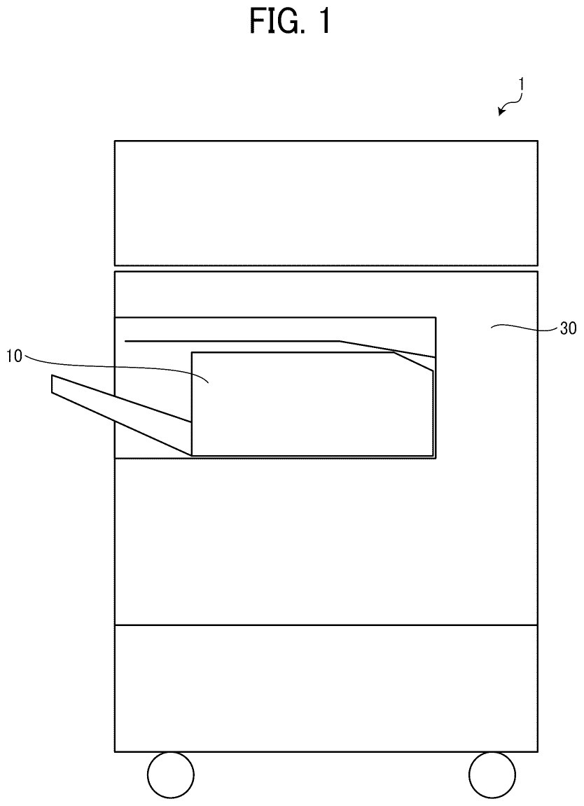

FIG. 1 is a diagram illustrating a schematic side view of an example of the overall configuration of an image forming apparatus according to a first embodiment of the present disclosure.

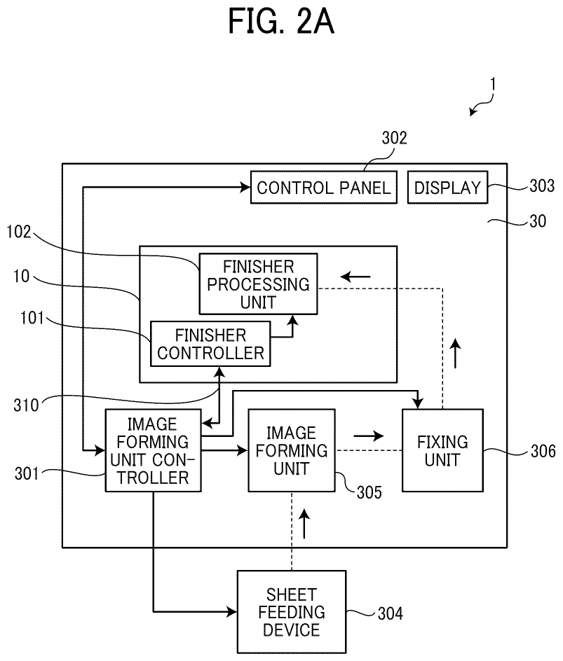

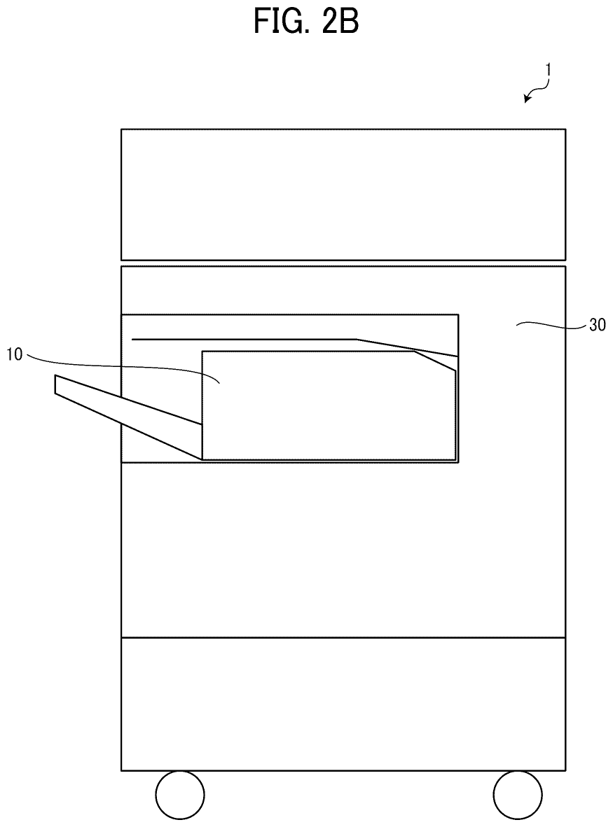

FIG. 2A is a diagram illustrating an example of a functional block of an image forming apparatus according to the first embodiment.

FIG. 2B is a diagram illustrating an example of a structure of the image forming apparatus of FIG. 2A.

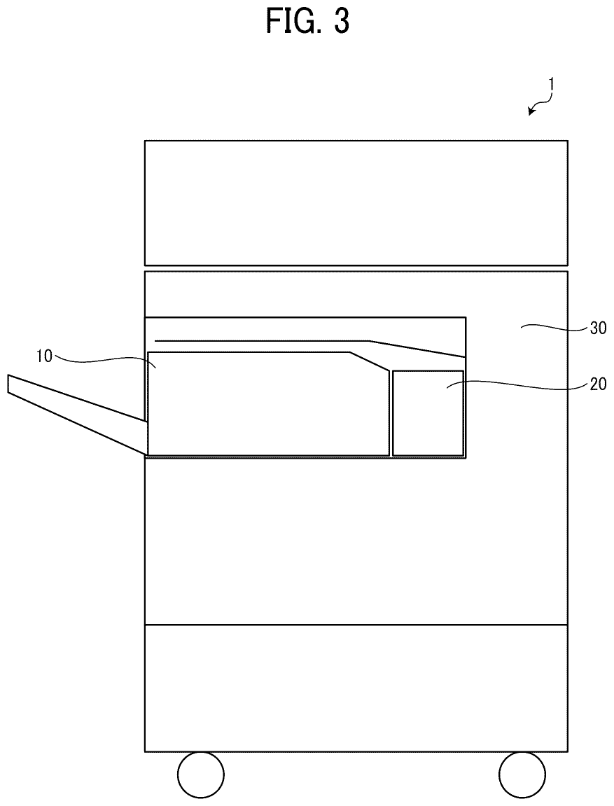

FIG. 3 is a diagram illustrating a schematic side view of another example of the overall configuration of an image forming apparatus according to the first embodiment of the present disclosure.

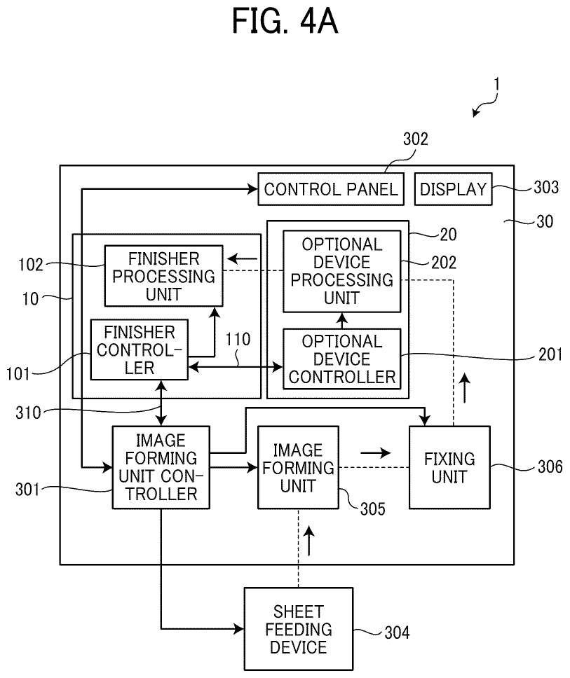

FIG. 4A is a diagram illustrating another example of a functional block of an image forming apparatus according to the first embodiment.

FIG. 4B is a diagram illustrating another example of a structure of the image forming apparatus of FIG. 4A.

With reference to FIGS. 1 to 4B, a description is given of the overall configuration and functional block configuration of an image forming apparatus 1 according to the present embodiment.

An image forming apparatus 1 illustrated in FIG. 1 is an image forming apparatus such as a multifunction peripheral (MFP) that forms an image on a sheet by, for example, an electrophotographic method. The MFP corresponds to an image forming apparatus having at least two functions of a copier function, a printer function, a scanner function, and a facsimile function. The image forming apparatus 1 includes an inner finisher 10 as an example of a post-processing apparatus, and an image forming device 30.

The inner finisher 10 is a device that performs a post-processing operation such as a sheet binding operation by a stapler. As illustrated in FIG. 2A, the inner finisher 10 includes a finisher controller 101 and a finisher processing unit 102. In each of FIGS. 2A and 2B, the flow of sheets is indicated by broken lines and the flow of communication signals is indicated by solid lines. The finisher controller 101 corresponds to a “determiner”, a “notification unit”, and a “controller”.

The finisher controller 101 is a functional unit that controls the operations of the inner finisher 10. The finisher controller 101 operates according to an instruction of an image forming unit controller 301 (to be described below) via a communication line 310.

The finisher processing unit 102 is a functional unit that follows the control by the finisher controller 101 to perform a given post-processing operation on a sheet on which an image is formed by the image forming device 30.

The image forming device 30 is a device that forms an image on a sheet fed from a sheet feeding device 304, which is described below, by, for example, an electrophotographic method. As illustrated in FIG. 2A, the image forming device 30 includes an image forming unit controller 301, a control panel 302, a display 303 (display unit), a sheet feeding device 304, an image forming unit 305, and a fixing unit 306.

The image forming unit controller 301 is a functional unit that controls the operations of the image forming device 30. The image forming unit controller 301 executes data communication with the finisher controller 101 of the inner finisher 10 via the communication line 310. The image forming unit controller 301 exchanges information regarding, for example, the mode, the sheet size, and the timing, with the finisher controller 101.

The control panel 302 is a functional unit for the user to perform a setting operation of, for example, the mode change and the number of sheets.

The display 303 is a unit to perform, for example, a display of the states of various devices and a display of notification of the operation contents.

The sheet feeding device 304 accommodates multiple sheets to be separated and fed one by one. The sheet fed and separated by the sheet feeding device 304 is conveyed to the image forming unit 305.

The image forming unit 305 forms an image on a sheet by forming a latent image on a photoconductor and transferring the image from the photoconductor onto the sheet. The sheet on which an image is transferred by the image forming unit 305 is conveyed to the fixing unit 306.

The fixing unit 306 fixes the image transferred on the sheet to the sheet. The sheet to which the image is fixed by the fixing unit 306 is conveyed to the finisher processing unit 102 of the inner finisher 10.

The configuration of the image forming apparatus 1 is not limited to the configuration illustrated in FIG. 1. For example, as illustrated in FIG. 3, the image forming apparatus 1 may further include an optional device 20 that is coupled to the inner finisher 10.

The optional device 20 executes a punching operation on the sheet on which the image is formed by the image forming device 30. The optional device 20 can be purchased after the user determines whether the optional device 20 is installed or not on the image forming apparatus 1. As illustrated in FIG. 4A, the optional device 20 includes an optional device controller 201 and an optional device processing unit 202. The optional device controller 201 is a functional unit that controls the operations of the optional device 20. The optional device controller 201 operates according to an instruction of the finisher controller 101 via a communication line 110. The optional device processing unit 202 executes a punching operation on the sheet on which an image is formed by the image forming device 30 (the sheet conveyed by the fixing unit 306).

The sheet processed by the optional device processing unit 202 is conveyed to the finisher processing unit 102 of the inner finisher 10. The following description is given of the image forming apparatus 1 having the configuration illustrated in FIGS. 1, 2A and 2B.

### Configuration of Inner Finisher

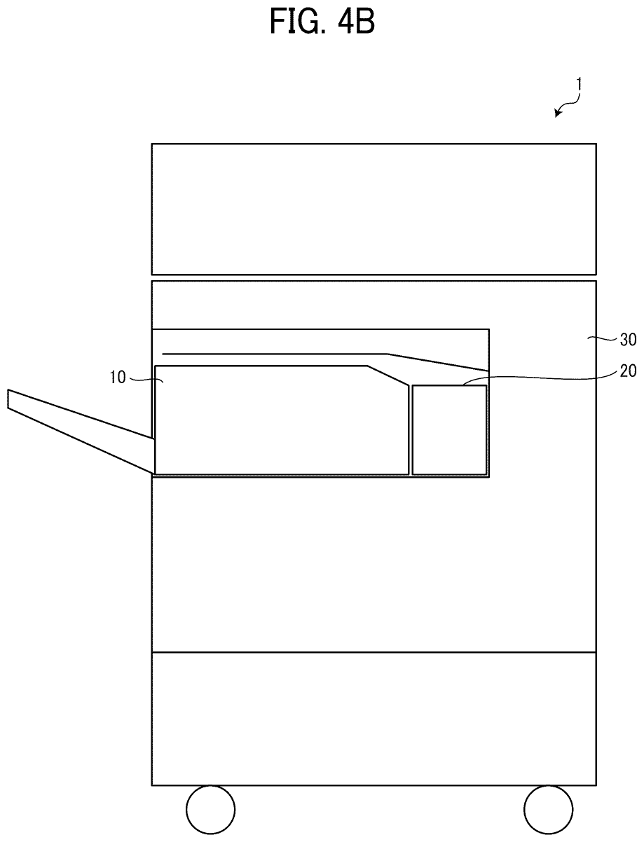

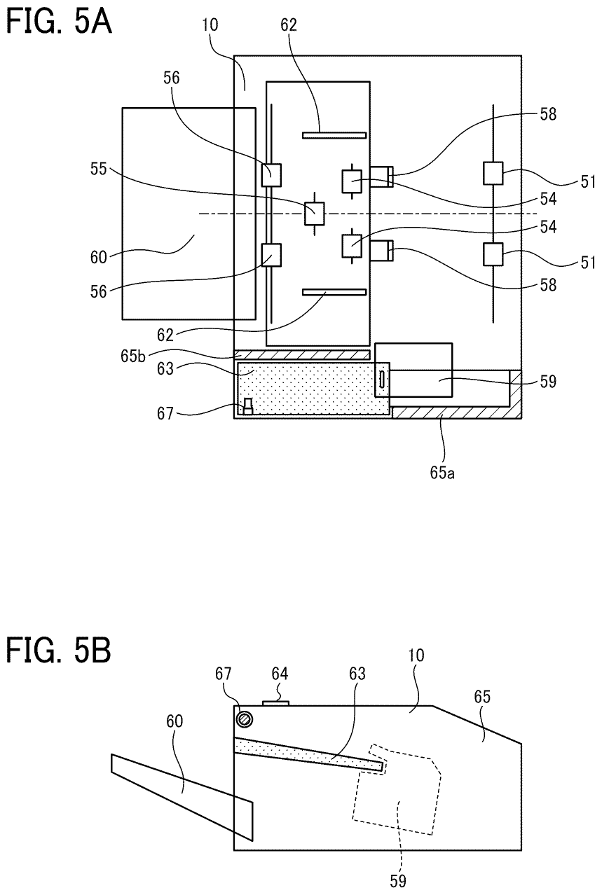

FIGS. 5A and 5B are diagrams illustrating a configuration of an inner finisher included in an image forming apparatus according to the first embodiment of the present disclosure.

Referring to FIGS. 5A and 5B, a description is given of the configuration of the inner finisher 10 of the image forming apparatus 1 according to the present embodiment. FIG. 5A is a top view of the inner finisher 10. FIG. 5B is a front view of the inner finisher 10.

As illustrated in FIGS. 5A and 5B, the inner finisher 10 includes an entrance roller 51, a return roller 54, a tapping roller 55, a sheet ejection roller 56, a reference fence 58, a stapler 59 (sheet binder), a sheet ejection tray 60, jogger fences 62, a staple slit 63, a start button 64, an exterior 65, a conveyance direction stopper 65a, a width direction stopper 65b, and a microphone 67 (sound collector).

The entrance roller 51 is an extreme upstream roller of the inner finisher 10. The return roller 54 is a roller for conveying the sheet toward the reference fence 58 and contacting the sheet against the reference fence 58. The tapping roller 55 is a roller for conveying the sheet toward the reference fence 58. The sheet ejection roller 56 is the extreme downstream roller of the inner finisher 10.

The reference fence 58 is a fence for aligning the conveyance direction of a sheet by causing the trailing end of the sheet to contact the reference fence 58 when performing, for example, the sheet binding operation.

The stapler 59 performs the sheet binding operation to bind a sheet bundle by causing a staple (or staples) to penetrate the sheet bundle.

The sheet ejection tray 60 is a tray to which the sheet is ejected. The jogger fences 62 sandwich the sheet to align the sheet in the width direction.

The staple slit 63 is an opening in the exterior 65 for inserting a sheet bundle and setting the sheet bundle in the opening of the stapler 59.

The start button 64 is a button for executing the sheet binding operation on the sheet bundle set in the staple slit 63.

The exterior 65 is an external part of the front side of the inner finisher 10. The conveyance direction stopper 65a is a contact member that contacts the sheet bundle in the conveyance direction when the sheet bundle is set in the staple slit 63. The width direction stopper 65b is a contact member that contacts the sheet bundle in the width direction when the sheet bundle is set in the staple slit 63.

The microphone 67 is a sound collector that collects, for example, sound for executing the sheet binding operation on the sheet bundle set in the staple slit 63. The microphone 67 is disposed on the exterior 65 of the inner finisher 10 so as to easily collect the sound or voice of the user. The position of the microphone 67 is not limited to the position illustrated in FIG. 5. The microphone 67 may be disposed at any position as long as the microphone 67 is attached to the inner finisher 10. Further, the shape of the microphone 67 is not limited to a round shape as illustrated in FIG. 5. The microphone 67 may have any shape such as an oval shape. Since the sheet binding operation by the stapler 59 can be performed by the sound or voice input via the microphone 67, even when a user is a physically handicapped person or the hands of the user are occupied, the sheet binding operation can be performed at any timing by emitting the sound or voice to the microphone 67.

### Hardware Configuration of Image Forming Apparatus

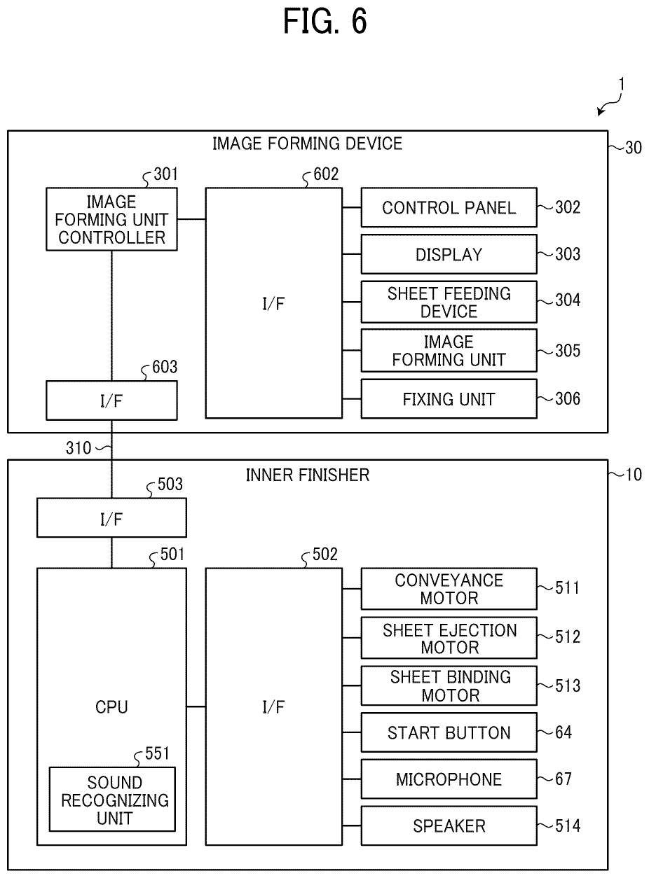

FIG. 6 is a block diagram illustrating an example of a hardware configuration of an image forming apparatus according to the first embodiment of the present disclosure.

Referring to FIG. 6, a description is given of a hardware configuration of the image forming apparatus 1 according to the present embodiment.

As illustrated in FIG. 6, the image forming device 30 includes the image forming unit controller 301, the control panel 302, the display 303, the sheet feeding device 304, the image forming unit 305, the fixing unit 306, an interface (I/F) 602, and an interface (I/F) 603. The image forming unit controller 301, the control panel 302, the display 303, the sheet feeding device 304, the image forming unit 305, and the fixing unit 306 have the configurations and functions described above.

The I/F 602 is an interface circuit for the image forming unit controller 301 to communicate with each of the control panel 302, the display 303, the sheet feeding device 304, the image forming unit 305, and the fixing unit 306.

The I/F 603 is an interface circuit for the image forming unit controller 301 to communication with a central processing unit (CPU) 501 of the inner finisher 10 via the communication line 310.

As illustrated in FIG. 6, the inner finisher 10 includes the CPU 501, an interface (I/F) 502, an interface (I/F) 503, a conveyance motor 511, a sheet ejection motor 512, a sheet binding motor 513, a start button 64, a microphone 67, and a speaker 514. The start button 64 and the microphone 67 have the configuration and function described above. Since the inner finisher 10 is an optional device that is similar to the optional device 20 described above, the inner finisher 10 is detachably attachable to the image forming device 30 via the I/F 503.

The CPU 501 is a processor that comprehensively controls operations of the inner finisher 10. The CPU 501 corresponds to the finisher controller 101 illustrated in FIG. 2. A sound recognition unit 551 illustrated in FIG. 6 is a functional portion that operates by executing a program by the CPU 501 to perform sound recognition on the sound or voice input by the microphone 67.

The I/F 502 is an interface circuit for the CPU 501 to communicate with each of the conveyance motor 511, the sheet ejection motor 512, the sheet binding motor 513, the start button 64, the microphone 67, and the speaker 514.

The I/F 503 is an interface circuit for the CPU 501 to communicate with the image forming unit controller 301 of the image forming device 30 via the communication line 310.

The conveyance motor 511 is a motor that controls rotation of the entrance roller 51. The sheet ejection motor 512 is a motor that controls rotation of the sheet ejection roller 56.

The sheet binding motor 513 is a motor that performs the sheet binding operation by the stapler 59 under the control of the CPU 501.

The speaker 514 is a device that outputs voice or sound under the control of the CPU 501. The “voice” indicates a word or words input by, for example, the user or the speaker 514. The “sound” indicates a sound other than the word or words output by, for example, the user or the speaker 514.

### Flow of Manual Binding Process of Inner Finisher of Image Forming Apparatus

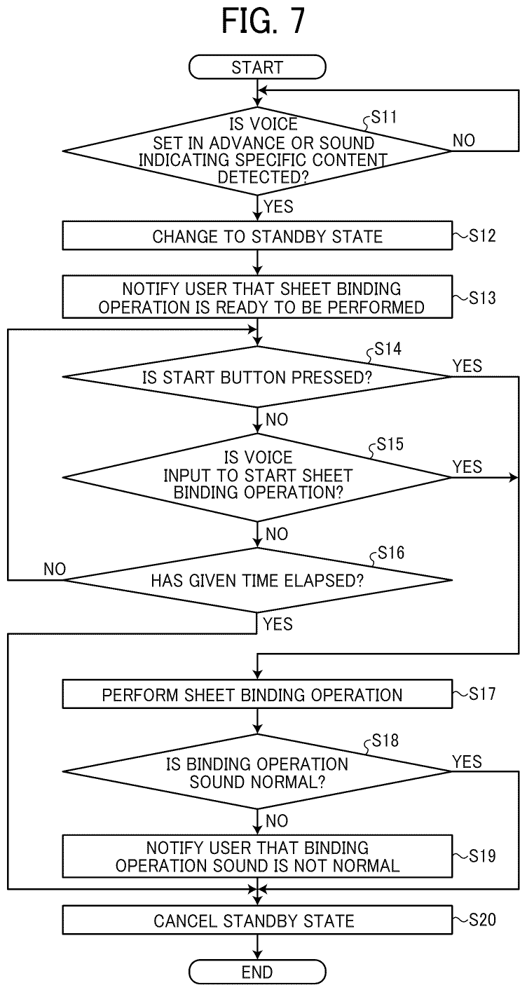

FIG. 7 is a flowchart of an example of a process for executing a manual binding operation of an inner finisher included in an image forming apparatus according to the first embodiment of the present disclosure.

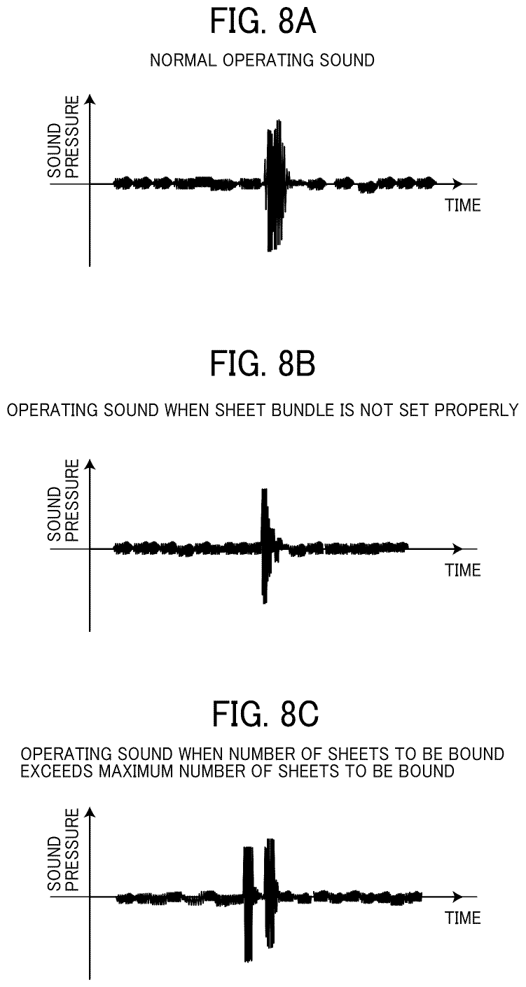

FIGS. 8A, 8B and 8C are diagrams each of which illustrates a waveform of sound when a stapler performs a sheet binding operation.

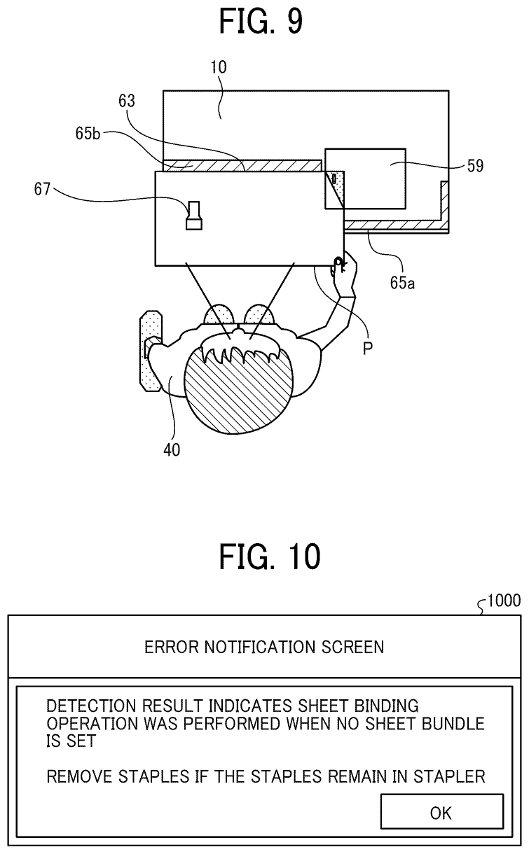

FIG. 9 is a diagram illustrating a case where a sheet binding operation is performed when a sheet bundle is not correctly set in an image forming apparatus according to the first embodiment of the present disclosure.

FIG. 10 is a diagram illustrating an example of a screen that is displayed when a sheet binding operation is performed when a sheet bundle is not correctly set in an image forming apparatus according to the first embodiment of the present disclosure.

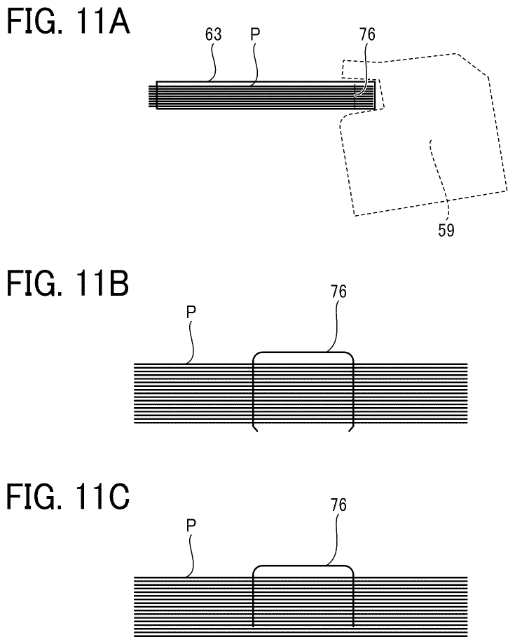

FIGS. 11A, 11B and 11C are diagrams each of which illustrates a case where a sheet binding operation is performed when a sheet bundle that exceeds the maximum number of sheets to be bound is set in an image forming apparatus according to the first embodiment of the present disclosure.

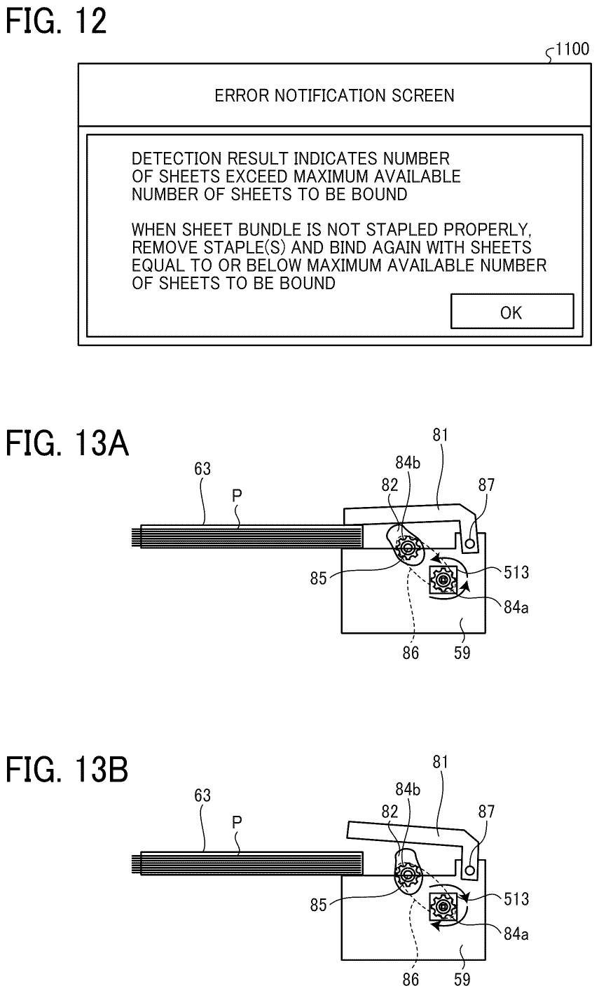

FIG. 12 is a diagram illustrating an example of a screen that is displayed when a sheet binding operation is performed when a sheet bundle that exceeds the maximum number of sheets to be bound is set in an image forming apparatus according to the first embodiment of the present disclosure.

FIGS. 13A and 13B are diagrams each of which illustrates a case where a sheet binding operation is performed when a sheet bundle that exceeds the maximum number of sheets to be bound in an image forming apparatus according to the first embodiment of the present disclosure.

Referring to FIGS. 7 and 13B, a description is given of the flow of a manual binding operation performed by of the inner finisher 10 of the image forming apparatus 1 according to the present embodiment.

### Step S11

The sound recognition unit 551 of the CPU 501 detects whether the voice of a user 40 input by the microphone 67 is a voice set in advance such as “standby mode” by the user 40 or a sound indicating a specific content, by the sound recognition. When the voice or sound is detected (YES in step S11), the process proceeds to step S12. When the voice or sound is not detected (NO in step S11), the process in step S11 is continued.

### Step S12

The CPU 501 changes the state to a standby state (preparation state) in which the stapler 59 can perform the sheet binding operation by the start button 64 or the microphone 67. As a result, before the CPU 501 changes to the standby state, the sheet binding operation by the stapler 59 can be prevented from being executed by the pressing of the start button 64 or the input of the voice to the microphone 67 for executing the sheet binding operation by the stapler 59, and the staple failure can be reduced or prevented. The condition for moving to the standby state is not limited to the above-described voice input by the microphone 67, and may be, for example, detection of a sound of the sheet bundle contacting the conveyance direction stopper 65a or the width direction stopper 65b when the sheet bundle is set in the staple slit 63. Then, the process proceeds to step S13.

### Step S13

The CPU 501 causes the speaker 514 to notify the user 40 that the sheet binding operation by the stapler 59 is ready to be performed. By so doing, the user 40 sets the sheet bundle in the staple slit 63. The notification may be an announcement by voice or may be output of, for example, beep sound. Then, the process proceeds to step S14.

### Step S14

The CPU 501 determines whether the start button 64 is pressed by the user 40. When the start button 64 is pressed (YES in step S14), the process proceeds to step S17. When the start button 64 is not pressed (NO in step S14), the process proceeds to step S15.

### Step S15

The sound recognition unit 551 determines whether the voice of the user 40 input by the microphone 67 is a voice for starting the sheet binding operation by the stapler 59 by the sound recognition.

When the voice is a voice for starting the sheet binding operation (YES in step S15), the process proceeds to step S17. When the voice is not a voice for starting the sheet binding operation (NO in step S15), the process proceeds to step S16.

### Step S16

The CPU 501 determines whether a given time (for example, 10 seconds) when the start button 64 is not pressed and the voice for starting the sheet binding operation is not input to the microphone 67 has elapsed. When the given time has not elapsed (NO in step S16), the process returns to step S14. When the given time has elapsed (YES in step S16), the process proceeds to step S20. As will be described below, the standby state is cancelled in step S20. As a result, when the sheet bundle is set by the user 40 but the sheet binding operation is not performed and the user 40 leaves after removing the sheet bundle, the sheet binding operation can be prevented from being performed when the user 40 does not intend to perform the sheet binding operation.

### Step S17

The CPU 501 causes the stapler 59 to perform the sheet binding operation on the sheet bundle set in the staple slit 63. Then, the process proceeds to step S18.

### Step S18

The CPU 501 inputs an operating sound generated in the sheet binding operation by the stapler 59 to the microphone 67. Then, the CPU 501 determines whether the operating sound input to the microphone 67 is normal. When the operating sound is normal (YES in step S17), the process proceeds to step S20. When the operating sound is abnormal (NO in step S17), the process proceeds to step S19.

An example of the operating sound is illustrated in FIGS. 8A, 8B and 8C, with the vertical line indicating the sound pressure and the horizontal line indicating the time.

FIG. 8A is a diagram illustrating the waveform of an operating sound of the sheet binding operation.

FIG. 8B is a diagram illustrating the waveform of an operating sound (abnormal) in the sheet binding operation when a sheet bundle is set properly.

FIG. 8C is a diagram illustrating the waveform of an operating sound (abnormal) in the sheet binding operation on a sheet bundle exceeding the maximum number of sheets to be bound.

For example, the CPU 501 (the sound recognition unit 551) can determine whether the operating sound input by the microphone 67 is normal by comparing the waveform of the operating sound input by the microphone 67 with the waveform of the normal operating sound as illustrated in FIG. 8A held in advance by the sound recognition. Further, the CPU 501 (the sound recognition unit 551) may hold in advance waveform information of the abnormal operating sound as illustrated in FIGS. 8B and 8C, and may determine the type of the abnormal operating sound by comparing the waveform information with these waveforms.

### Step S19

The CPU 501 notifies the user 40 that the operating sound is abnormal, in other words, that the sheet binding operation of the stapler 59 is defective, by displaying the information on the display 303 via the image forming unit controller 301.

For example, FIG. 9 illustrates the state in which the sheet binding operation is performed by the stapler 59 when the user 40 sets the sheet bundle P in the staple slit 63 with the leading end of the sheet bundle P bent. As described above, when the sheet binding operation is performed with the leading end of the sheet bundle P bent as illustrated in FIG. 9 or when the sheet bundle P is removed during the sheet binding operation, the staple remains in the stapler 59. In this case, the CPU 501 determines that the operating sound input to the microphone 67 is abnormal, further determines that the operating sound is an operating sound in a case where the sheet binding operation is performed when the sheet bundle P is not correctly set, and causes the display 303 to display an error notification screen 1000 indicating the determination result, as illustrated in FIG. 10. As illustrated in FIG. 10, the error notification screen 1000 is a screen indicating a content for prompting removal of the staple from the stapler 59. If the sheet binding operation is performed when the staple remains in the stapler 19, a failure of the stapler 59 is caused. In order to handle such a situation, the user 40 can remove the staple remaining in the stapler 59 by the notification by, for example, the display on the error notification screen 1000, and can prevent the failure of the stapler 59.

The sheet binding operation with the stapler 59 is not limited to the sheet binding operation with staples, and may be a sheet binding operation without staples. Similarly, the CPU 501 may notify the user 40 that the sheet binding operation is performed when no sheet bundle P is set.

Further, FIGS. 11A, 11B and 11C illustrate states where the stapler 59 has performed the sheet binding operation on the sheet bundle P exceeding the maximum number of sheets to be bound.

In particular, FIG. 11A illustrates a state where the stapler 59 performs the sheet binding operation on the sheet bundle P exceeding the maximum number of sheets to be bound.

FIG. 11B illustrates a state where the tip of the staple 76 with which the sheet binding operation has been performed on the sheet bundle P exceeding the maximum number of sheets to be bound protrudes from the sheet bundle P.

FIG. 11C illustrates a state where the staple 76 with which the sheet binding operation has been performed on the sheet bundle P exceeding the maximum number of sheets to be bound does not penetrate and is stuck in the middle of the sheet bundle P.

In this case, the CPU 501 determines that the operating sound input to the microphone 67 is abnormal, further determines that the operating sound is an operating sound when the sheet binding operation is performed on the sheet bundle P exceeding the maximum number of sheets to be bound, that is, an operating sound of the sheet binding operation when the staple 76 does not properly penetrate the sheet bundle P, and causes the display 303 to display an error notification screen 1100 indicating the determination result, as illustrated in FIG. 12. As illustrated in FIG. 12, the error notification screen 1100 is a screen indicating a content for prompting the sheet binding operation on the sheet bundle P with an appropriate number of sheets to be bound. At this time, since the stapler 59 locks the sheet bundle P, the sheet bundle P is damaged when the sheet bundle P is pulled out. However, since the user 40 can be notified of the state by the notification by displaying, for example, the error notification screen 1100, the damage of the sheet bundle P can be prevented.

As described above, the CPU 501 causes the display 303 to display the content according to the type of the operating sound input to the microphone 67.

The sheet binding operation with the stapler 59 is not limited to the sheet binding operation with staples, and may be a sheet binding operation without staples. Similarly, the CPU 501 may notify the user 40 that the sheet binding operation is performed on the sheet bundle P exceeding the maximum number of sheets to be bound.

Further, FIG. 13A illustrates the state where the stapler 59 locks the sheet bundle P when the stapler 59 has performed the sheet binding operation on the sheet bundle P exceeding the maximum number of sheets to be bound, as illustrated in FIGS. 11A, 11B and 11C. As illustrated in FIG. 13A, the stapler 59 includes a staple feeder 81, a cam 82, a pulley 84a, a pulley 84b, a rotary shaft 85, a belt 86, and a rotary shaft 87.

The staple feeder 81 nips the sheet bundle P by rotating on the rotary shaft 87 for sticking a staple into the sheet bundle P. As the pulley 84b is rotated by the belt 86, the cam 82 rotates about the rotary shaft 85 to push up the staple feeder 81. The pulley 84a is rotated with the rotational driving of the sheet binding motor 513. The belt 86 is wound around the pulley 84a and the pulley 84b. The pulley 84b is rotated via the belt 86 with the rotation of the pulley 84a along with the rotational driving of the sheet binding motor 513. The rotary shaft 85 is a rotation shaft of the cam 82. The belt 86 is stretched between the pulleys 84a and 84b. The rotary shaft 87 is a rotation shaft in a case where the staple feeder 81 is driven to nip the sheet bundle.

As described above, when the CPU 501 determines that the operating sound input to the microphone 67 is abnormal and further discriminates that the operating sound is an operating sound when the sheet binding operation is performed on the sheet bundle P exceeding the maximum number of sheets to be bound, the sheet binding motor 513 is rotated in the reverse direction to rotate the cam 82 in the reverse direction, as illustrated in FIG. 13B, so as to move the staple feeder 81 upward (to the home position).

By so doing, the stapler 59 can cancel the locked state of the sheet bundle P. As a result, the sheet bundle P can be prevented from being damaged by pulling out the sheet bundle P in the locked state.

When the series of operations in step S19 as described above is completed, the process proceeds to step S20.

### Step S20

The CPU 501 cancels the standby state. By cancelling the standby state, the sheet binding operation prevented from being performed on the same sheet bundle P continuously when the sheet bundle P remains in the staple slit 63.

The operations of steps S1 to S20 described above are repeatedly executed.

As described above, in the inner finisher 10 of the image forming apparatus 1 according to the present embodiment, the stapler 59 performs the sheet binding operation on the sheet bundle, the microphone 67 inputs the operating sound of the sheet binding operation with the stapler 59, and the CPU 501 determines whether the operating sound input by the microphone 67 is normal or not. When the operating sound is not normal, the CPU 501 notifies the user that the sheet binding operation is defective. Accordingly, when the sheet binding operation on the sheet bundle is defective, the occurrence of the failure of the stapler 59 and the damage on the sheet bundle can be reduced or prevented.

### Second Embodiment

A description is given of an image forming apparatus according to a second embodiment of the present disclosure, regarding the difference from the image forming apparatus 1 according to the first embodiment of the present disclosure.

In the present embodiment, the description is given of the configuration including a sensor that detects the sheet bundle P set in the staple slit 63. The overall configuration of the image forming apparatus according to the present embodiment is the same as those described in the first embodiment.

### Configuration of Inner Finisher

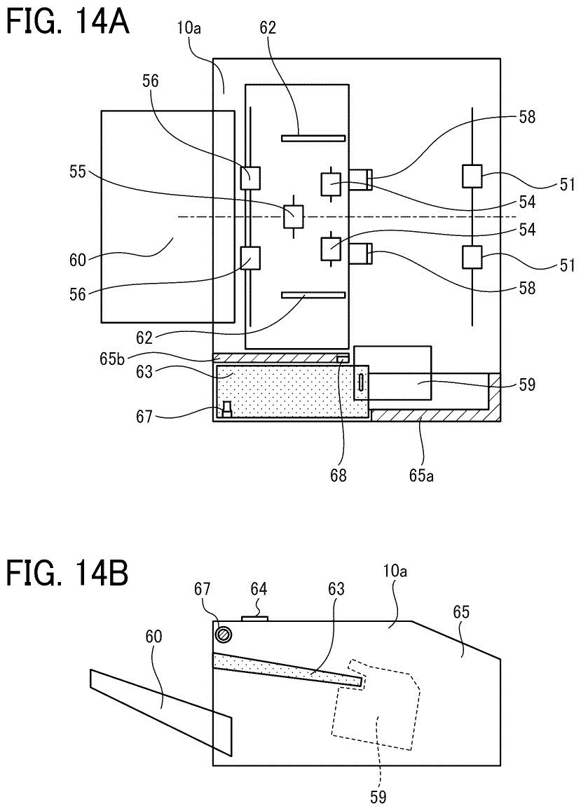

FIGS. 14A and 14B are diagrams illustrating a configuration of an inner finisher included in an image forming apparatus according to the second embodiment of the present disclosure.

Referring to FIGS. 14A and 14B, a description is given of the configuration of the inner finisher 10 of an image forming apparatus 1a according to the present embodiment.

FIG. 14A is a top view of an inner finisher 10a.

FIG. 14B is a front view of the inner finisher 10a.

As illustrated in FIGS. 14A and 14B, the inner finisher 10a includes an entrance roller 51, a return roller 54, a tapping roller 55, a sheet ejection roller 56, a reference fence 58, a stapler 59, a sheet ejection tray 60, jogger fences 62, a staple slit 63, a start button 64, an exterior 65, a conveyance direction stopper 65a, a width direction stopper 65b, a microphone 67, and a sheet bundle detection sensor 68 (first detector). The configurations of these devices and units in the inner finisher 10a other than the sheet bundle detection sensor 68 are the same as the configurations of the devices and units in the inner finisher 10 according to the first embodiment.

The sheet bundle detection sensor 68 is a sensor that detects the sheet bundle P set in the staple slit 63.

### Hardware Configuration of Image Forming Apparatus

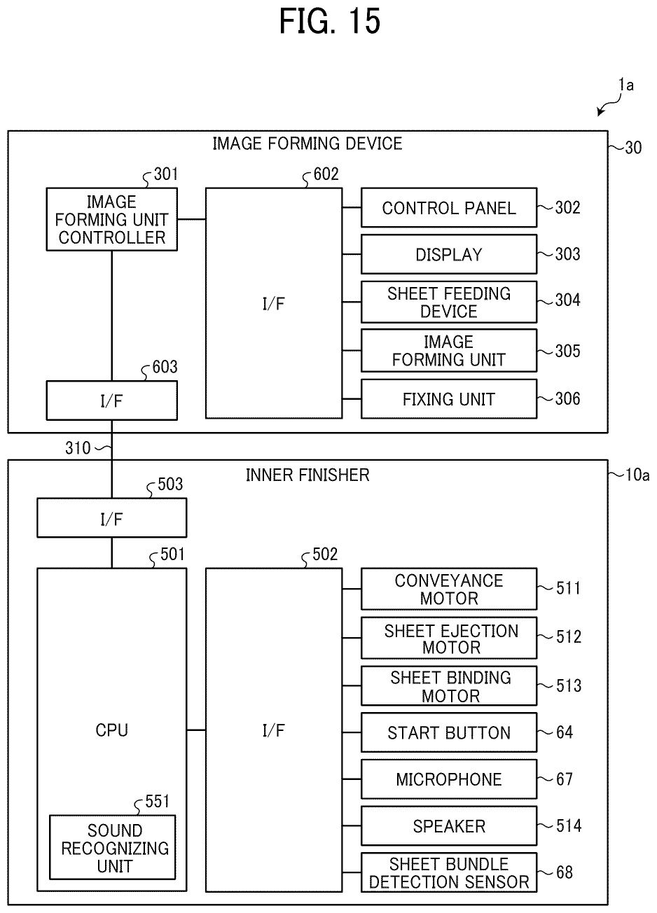

FIG. 15 is a block diagram illustrating an example of a hardware configuration of an image forming apparatus according to the second embodiment of the present disclosure.

Referring to FIG. 15, a description is given of a hardware configuration of the image forming apparatus 1a according to the present embodiment.

As illustrated in FIG. 15, the image forming apparatus 1a includes the inner finisher 10a and an image forming device 30. The configuration of the image forming device 30 of the image forming apparatus 1a is the same as the configuration in the image forming device 30 of the image forming apparatus 1 according to the first embodiment.

As illustrated in FIG. 15, the inner finisher 10a includes a central processing unit (CPU) 501, an interface (I/F) 502, an interface (I/F) 503, a conveyance motor 511, a sheet ejection motor 512, a sheet binding motor 513, a start button 64, a microphone 67, a speaker 514, and a sheet bundle detection sensor 68 (first detector). The configurations of these devices and units in the inner finisher 10a other than the sheet bundle detection sensor 68 are the same as the configurations of the devices and units in the inner finisher 10 according to the first embodiment.

A detection signal detected by the sheet bundle detection sensor 68 is transmitted to the CPU 501 via the I/F 502.

### Flow of Manual Binding Process of Inner Finisher of Image Forming Apparatus

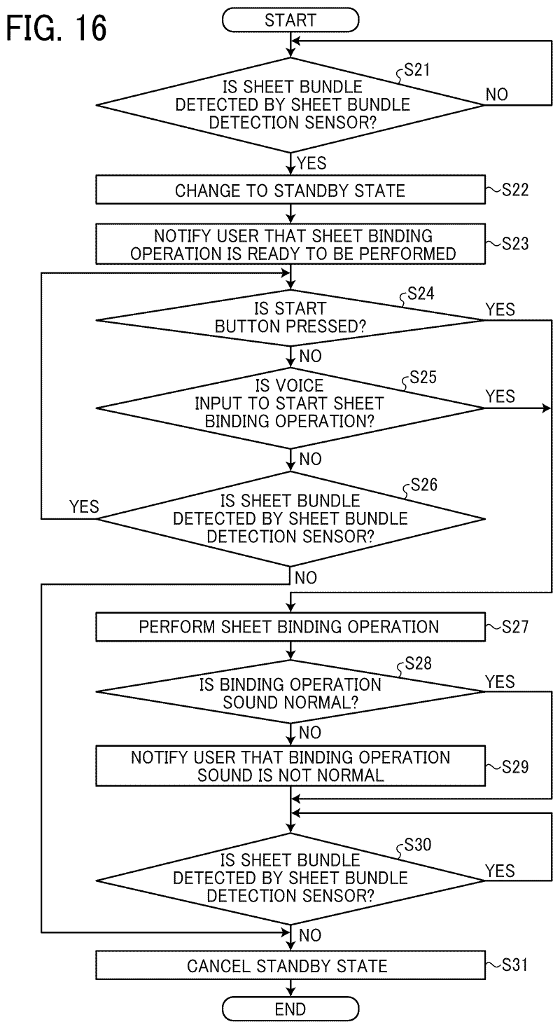

FIG. 16 is a flowchart of an example of a process for executing a manual binding operation of an inner finisher included in an image forming apparatus according to the second embodiment of the present disclosure.

Referring to FIG. 16, a description is given of the flow of a manual binding operation performed by of the inner finisher 10a of the image forming apparatus 1a according to the present embodiment.

### Step S21

The CPU 501 determines whether the sheet bundle P is detected by the sheet bundle detection sensor 68 that the sheet bundle P is set in the staple slit 63. When the sheet bundle P is set in the staple slit 63 (YES in step S21), the process proceeds to step S22. When the sheet bundle P is not set in the staple slit 63 (NO in step S21), the process in step S21 is continued.

### Steps S22 to S25

The operations of steps S22 to S25 are the same as the operations of steps S12 to S15, respectively, illustrated in FIG. 7 described above.

### Step S26

The CPU 501 determines whether the sheet bundle P is detected by the sheet bundle detection sensor 68 that the sheet bundle P remains set in the staple slit 63. When the sheet bundle P remains set in the staple slit 63 (YES in Step S26), the process returns to step S24. On the other hand, when the sheet bundle P does not remain set in the staple slit 63 (NO in step S26), the process proceeds to step S31. As will be described below, the standby state is cancelled in step S31. As a result, when the sheet bundle is set by the user 40 but the sheet binding operation is not performed and the user 40 leaves after removing the sheet bundle, the sheet binding operation can be prevented from being performed when the user 40 does not intend to perform the sheet binding operation.

### Steps S27 to S29

The operations of steps S27 to S29 are the same as the operations of steps S17 to S19, respectively, illustrated in FIG. 7 described above. Then, the process proceeds to step S30 after completion of step S29.

### Step S30

The CPU 501 determines whether the sheet bundle P is detected by the sheet bundle detection sensor 68 that the sheet bundle P remains set in the staple slit 63. When the sheet bundle P is removed from the staple slit 63 (NO in step S30), the process proceeds to step S31. When the sheet bundle P remains set in the staple slit 63 (YES in step S30), the process in step S30 is continued. When the start button 64 is pressed or when a voice or sound for starting the sheet binding operation is input to the microphone 67, with the sheet bundle P set in the staple slit 63, the CPU 501 may notify the user that the sheet binding operation process may not be performed, via the display 303 or by outputting the notification from the speaker 514.

### Step S31

The CPU 501 cancels the standby state. By cancelling the standby state, the sheet binding operation prevented from being performed on the same sheet bundle P continuously when the sheet bundle P remains in the staple slit 63.

The operations of steps S21 to S31 described above are repeatedly executed.

As described above, in the inner finisher 10a of the image forming apparatus 1a according to the present embodiment, the sheet bundle detection sensor 68 detects the sheet bundle P set in the stapler 59. When the sheet bundle detection sensor 68 detects the sheet bundle, the CPU 501 causes the sheet bundle to move to the standby state available for the sheet binding operation by the stapler 59. When the voice or sound for starting the sheet binding operation is input to the microphone 67 or when the start button 64 for starting the sheet binding operation is operated, the sheet binding operation is performed with the sheet bundle in the standby state. By so doing, the sheet binding operation is prevented from being performed, with the sheet bundle not being set in the stapler 59.

### Third Embodiment

A description is given of an image forming apparatus according to a third embodiment of the present disclosure, regarding the difference from the image forming apparatus 1a according to the second embodiment of the present disclosure.

In the present embodiment, a description is given of the operation in which the sound collection direction of the microphone 67 is changed to a direction to the user. The overall configuration of the image forming apparatus 1 according to the present embodiment is the same as the configuration described in the first embodiment.

### Configuration of Inner Finisher

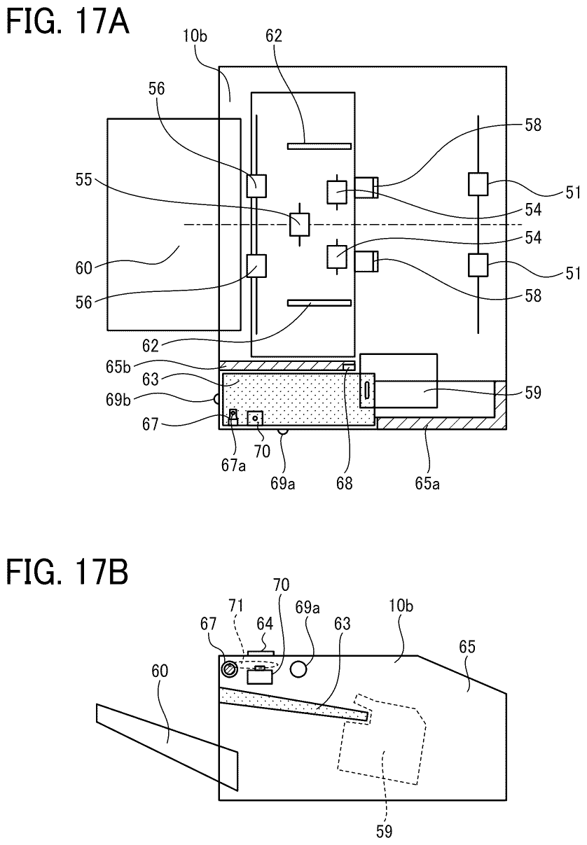

FIGS. 17A and 17B are diagrams illustrating a configuration of an inner finisher included in an image forming apparatus according to the third embodiment of the present disclosure.

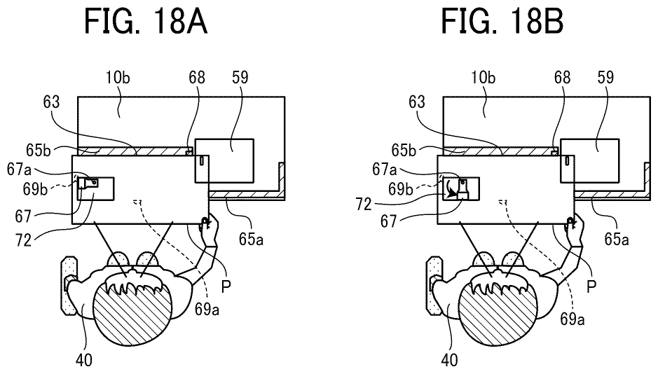

FIGS. 18A and 18B are diagrams each of which illustrates an operation of an inner finisher included in an image forming apparatus according to the third embodiment of the present disclosure.

Referring to FIGS. 17A, 17B, 18A and 18B, a description is given of the configuration of an inner finisher 10b of an image forming apparatus 1b according to the present embodiment.

FIG. 17A is a top view of the inner finisher 10b.

FIG. 17B is a front view of the inner finisher 10b.

As illustrated in FIGS. 17A and 17B, the inner finisher 10b (as an example of a post-processing apparatus) includes an entrance roller 51, a return roller 54, a tapping roller 55, a sheet ejection roller 56, a reference fence 58, a stapler 59, a sheet ejection tray 60, jogger fences 62, a staple slit 63, a start button 64, an exterior 65, a conveyance direction stopper 65a, a width direction stopper 65b, a microphone 67, a sheet bundle detection sensor 68 (first detector), a motion sensor 69a, a motion sensor 69b, a rotation motor 70, and a belt 71. The configurations of these devices and units in the inner finisher 10b other than the microphone 67, the motion sensor 69a, the motion sensor 69b, the rotation motor 70, and the belt 71 are the same as the configurations of the devices and units in the inner finisher 10a according to the second embodiment. The motion sensor 69a and the motion sensor 69b are examples of the “second detector” in the present disclosure.

The motion sensor 69a is a sensor that detects a motion of a person who is present on the front side of the inner finisher 10b. The motion sensor 69b is a sensor that detects a motion of a person who is present on the side face side of the inner finisher 10b. The motion sensor 69a and the motion sensor 69b are infrared sensors that detect infrared rays emitted by a person to detect the presence or absence of the person, ultrasonic sensors, camera sensors that detect the presence or absence of the person from, for example, a captured image.

The positions of the motion sensor 69a and the motion sensor 69b are not limited to the positions illustrated in FIGS. 17A and 17B. The motion sensor 69a and the motion sensor 69b may be arranged at any positions as long as the motion sensor 69a and the motion sensor 69b can detect a user. Further, the present disclosure is not limited to the arrangement of multiple motion sensors such as the motion sensor 69a and the motion sensor 69b. For example, when the motion sensor 69a alone is mounted on the inner finisher 10b and the user is detected by the motion sensor 69a, the microphone 67 may be rotated such that the sound collection direction of the microphone 67 faces the front direction of the inner finisher 10b. On the other hand, when the motion sensor 69a alone is mounted on the inner finisher 10b and the user is not detected by the motion sensor 69a, the microphone 67 may be rotated such that the sound collection direction of the microphone 67 faces the sheet ejection direction of the inner finisher 10b.

The rotation motor 70 is a motor that drives to rotate the microphone 67 in the left-and-right direction via the belt 71 to change the sound collection direction of the microphone 67. The belt 71 is a belt stretched between the rotary shaft of the rotation motor 70 and the rotary shaft 67a of the microphone 67.

The microphone 67 rotates in the left-and-right direction about the rotary shaft 67a due to the driving and rotation of the rotation motor 70 in the space 72, so as to change the sound collection direction. In FIG. 18A, the sound collection direction of the microphone 67 is not the direction in which the user 40 is located. When the sheet bundle P is set in the staple slit 63 by the user 40 and the motion sensor 69a detects the user 40 in front of the inner finisher 10b, the microphone 67 rotates about the rotary shaft 67a to change the sound collection direction to the direction of the user 40, as illustrated in FIG. 18B. As a result, the microphone 67 can easily collect sound that is the voice of the user 40.

### Hardware Configuration of Image Forming Apparatus

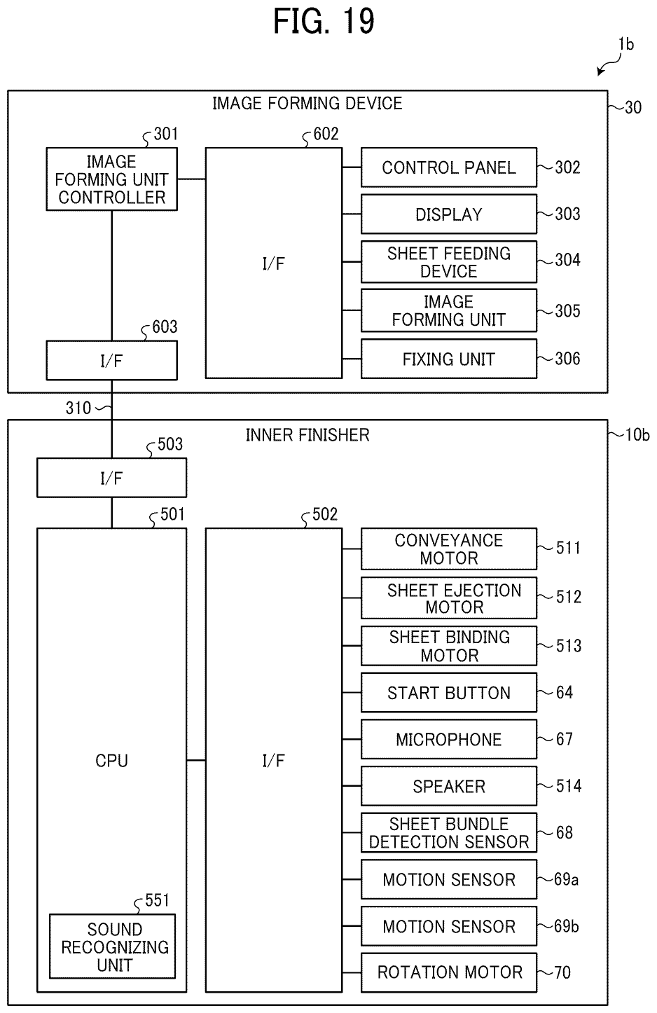

FIG. 19 is a block diagram illustrating an example of a hardware configuration of an image forming apparatus according to the third embodiment of the present disclosure.

Referring to FIG. 19, a description is given of a hardware configuration of the image forming apparatus 1b according to the present embodiment.

As illustrated in FIG. 19, the image forming apparatus 1b includes the inner finisher 10b and an image forming device 30. The configuration of the image forming device 30 of the image forming apparatus 1b is the same as the configuration in the image forming device 30 of the image forming apparatus 1 according to the first embodiment.

As illustrated in FIG. 19, the inner finisher 10b includes a central processing unit (CPU) 501, an interface (I/F) 502, an interface (I/F) 503, a conveyance motor 511, a sheet ejection motor 512, a sheet binding motor 513, a start button 64, a microphone 67, a speaker 514, a sheet bundle detection sensor 68 (first detector), a motion sensor 69a, a motion sensor 69b, and a rotation motor 70. The configurations of these devices and units in the inner finisher 10b other than the motion sensor 69a, the motion sensor 69b, and the rotation motor 70 are the same as the configurations of the devices and units in the inner finisher 10a according to the second embodiment. The motion sensor 69a and the motion sensor 69b are examples of the “second detector” in the present disclosure.

Detection signals detected by the motion sensor 69a and the motion sensor 69b are transmitted to the CPU 501 via the I/F 502. The CPU 501 controls the rotation of the rotation motor 70 via the I/F 502.

### Flow of Manual Binding Process of Inner Finisher of Image Forming Apparatus

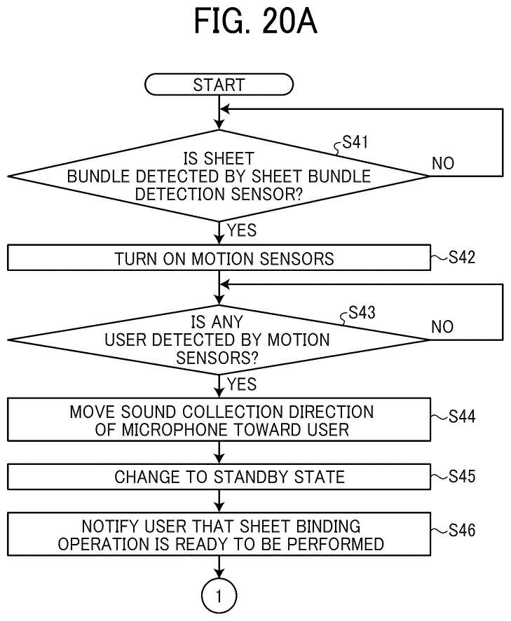

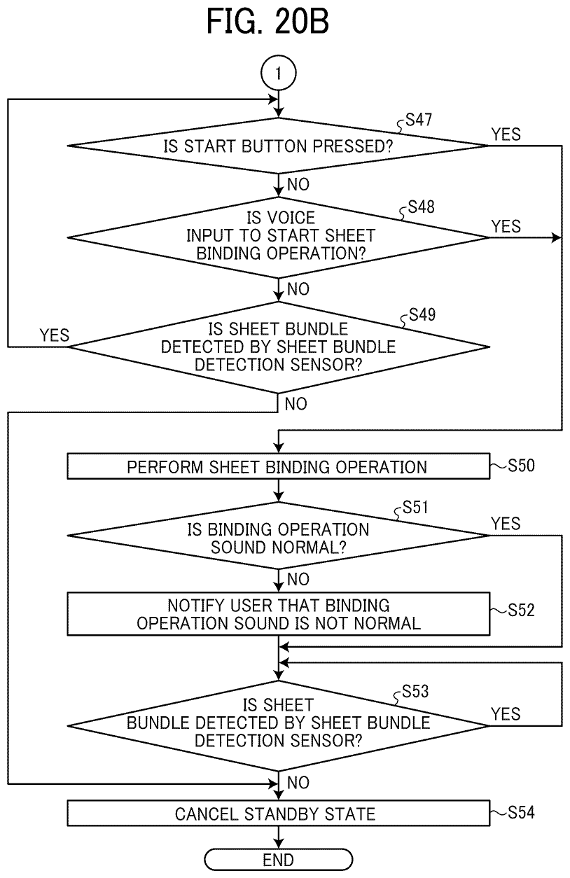

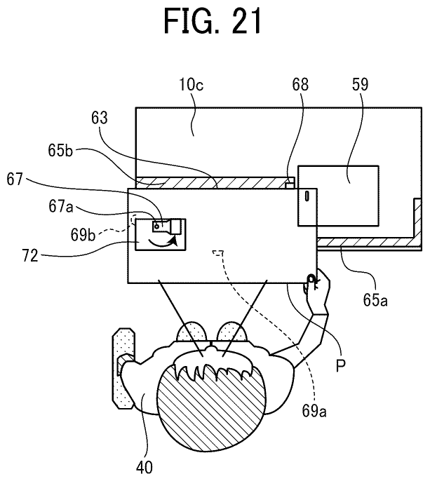

FIGS. 20A and 20B are separated drawings of a flowchart of an example of a process for executing a manual binding operation of an inner finisher included in an image forming apparatus according to the third embodiment of the present disclosure.

Referring to FIGS. 20A and 20B, a description is given of the flow of the manual binding operation performed by of the inner finisher 10b of the image forming apparatus 1b according to the present embodiment.

### Step S41

The CPU 501 determines whether the sheet bundle P is detected by the sheet bundle detection sensor 68 that the sheet bundle P is set in the staple slit 63. When the sheet bundle P is set in the staple slit 63 (YES in step S41), the process proceeds to step S42. When the sheet bundle P is not set in the staple slit 63 (NO in step S41), the process in step S41 is continued.

### Step S42

The CPU 501 turns on (enables) the detection operation of the motion sensor 69a and the motion sensor 69b. Then, the process proceeds to step S43.

### Step S43

Then, the CPU 501 determines whether a person (user) is present around the image forming apparatus 1b by the motion sensor 69a and the motion sensor 69b. When the person (the user in this case) is present (detected) around the image forming apparatus 1b (YES in step S43), the process proceeds to step S44. When the person is not present (detected) (NO in step S43), the process in step S43 is continued.

### Step S44

The CPU 501 causes the microphone 67 to rotate by the rotation motor 70 so that the sound collection direction of the microphone 67 is the direction of the user 40 detected by the motion sensor 69a or the motion sensor 69b. For example, when the user 40 is detected by the motion sensor 69a, the CPU 501 causes the microphone 67 to rotate so that the sound collection direction of the microphone 67 is moved to the front direction toward the user 40. When the user 40 is detected by the motion sensor 69b, the CPU 501 causes the microphone 67 to rotate so that the sound collection direction of the microphone 67 is moved the side face direction, in other words, the detection direction of the motion sensor 69b. Then, the process proceeds to step S45.

### Steps S45 to S54

The operations of steps S45 to S54 are the same as the operations of steps S22 to S31, respectively, illustrated in FIG. 16 described above.

The operations of steps S41 to S54 described above are repeatedly executed.

As described above, in the inner finisher 10b of the image forming apparatus 1b according to the present embodiment, the motion sensor 69a and the motion sensor 69b detect the motion of a person (user) and the CPU 501 causes the microphone 67 to change the sound collection direction according to the detected state by the motion sensor 69a and the motion sensor 69b. As a result, the microphone 67 can easily collect sound that is the voice of the user 40.

### Modification of Third Embodiment

A description is given of an image forming apparatus according to a modification of the third embodiment of the present disclosure, regarding the difference from the image forming apparatus 1b according to the third embodiment of the present disclosure.

In the present modification, a description is given of the operation of effectively collecting an operating sound in the sheet binding operation by the stapler 59. The overall configuration and hardware configuration of an image forming apparatus and configuration of an inner finisher are the same as those described in the third embodiment described above.

FIG. 21 is a diagram illustrating an operation of an inner finisher included in an image forming apparatus according to the third embodiment of the present disclosure.

Referring to FIGS. 21, a description is given of the configuration of an inner finisher 10c (as an example of a post-processing apparatus) of an image forming apparatus (an image forming apparatus 1c in this modification) according to the present modification.

In the present modification, as illustrated in FIG. 21, the microphone 67 rotates about the rotary shaft 67a immediately before the sheet binding operation by the stapler 59, so as to change the sound collection direction to the direction of the stapler 59. As a result, the microphone 67 can easily collect the operating sound of the sheet binding operation of the stapler 59.

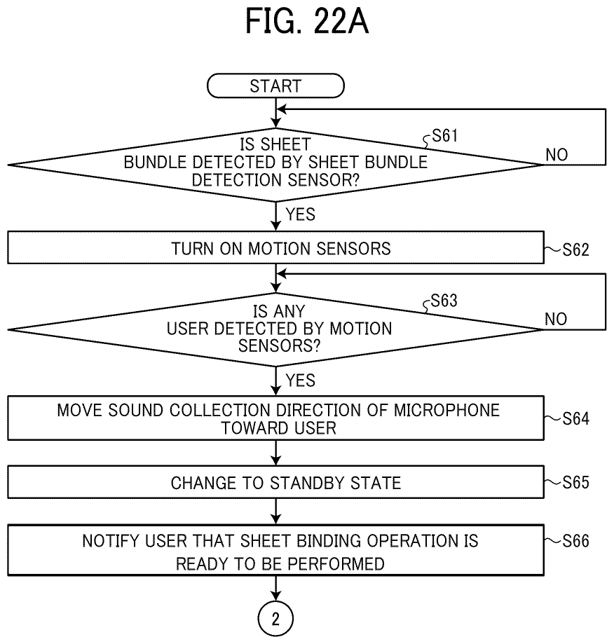

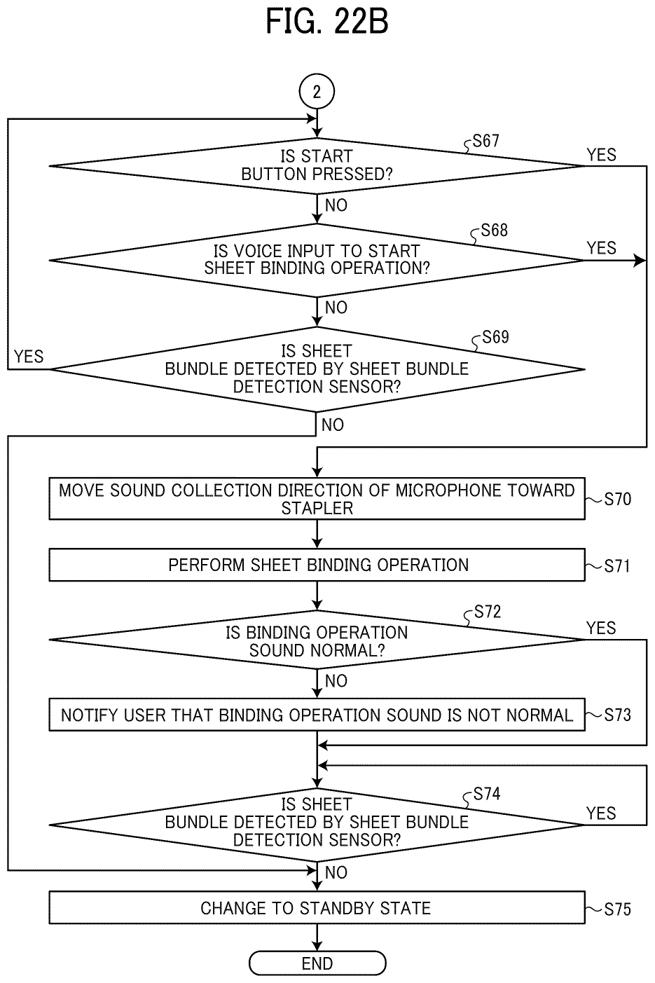

FIGS. 22A and 22B are separated diagrams of a flowchart of an example of a process for executing a manual binding operation of an inner finisher included in an image forming apparatus according to the third embodiment of the present disclosure.

Referring to FIGS. 22A and 22B, a description is given of the flow of the manual binding operation performed by the inner finisher 10c of the image forming apparatus 1c according to the present modification.

### Steps S61 to S69

The operations of steps S61 to S69 are the same as the operations of steps S41 to S49, respectively, illustrated in FIG. 20 described above. In step S67, when the start button 64 is pressed (YES in step S67), the process proceeds to step S70. Further, in step S68, when a voice (sound) for starting the sheet binding operation is input to the microphone 67 (YES in step S68), the process proceeds to step S70.

### Step S70

The CPU 501 causes the microphone 67 to rotate by the rotation motor 70 so that the sound collection direction of the microphone 67 is the direction in which the stapler 59 is disposed. As a result, the microphone 67 can easily collect the operating sound of the sheet binding operation of the stapler 59, and the accuracy of the sound recognition by the sound recognition unit 551 can be enhanced. The process then proceeds to step S71.

### Steps S71 to S75

The operations of steps S71 to S75 are the same as the operations of steps S50 to S54, respectively, illustrated in FIG. 20 described above.

The operations of steps S61 to S75 described above are repeatedly executed.

As described above, in the inner finisher 10c of the image forming apparatus 1c according to the present modification, the CPU 501 causes the microphone 67 to change the sound collection direction of the microphone 67 to the direction in which the stapler 59 is disposed, before the sheet binding operation is performed. As a result, the microphone 67 can easily collect the operating sound of the sheet binding operation of the stapler 59, and the accuracy of the sound recognition by the sound recognition unit 551 can be enhanced.

### Fourth Embodiment

A description is given of an image forming apparatus according to a fourth embodiment of the present disclosure, regarding the difference from the image forming apparatus 1a according to the second embodiment of the present disclosure.

In the present embodiment, a description is given of the operation in which the sound collection direction of the microphone 67 is changed to a direction to the user by moving the microphone 67 along a guide. The overall configuration of the image forming apparatus 1 according to the present embodiment is the same as the configuration described in the first embodiment.

### Configuration of Inner Finisher

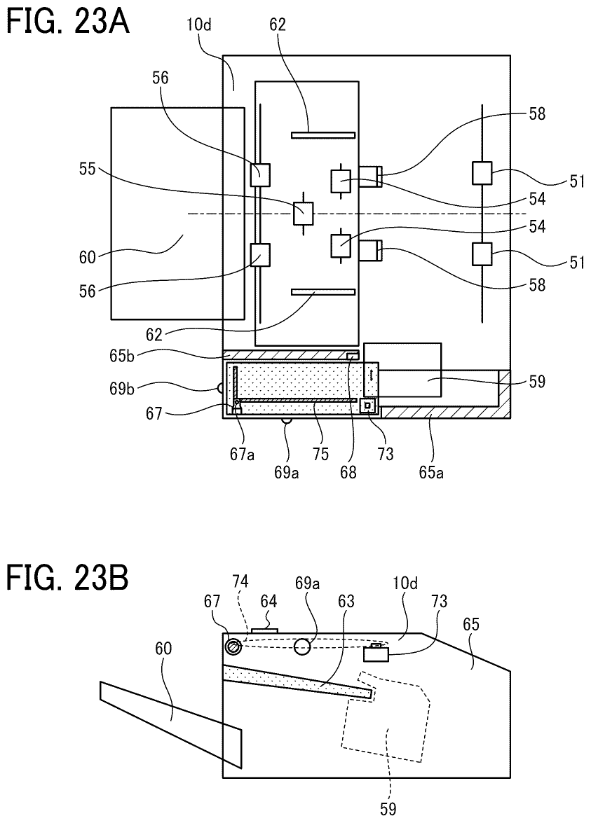

FIGS. 23A and 23B are diagrams illustrating a configuration of an inner finisher included in an image forming apparatus according to the fourth embodiment of the present disclosure.

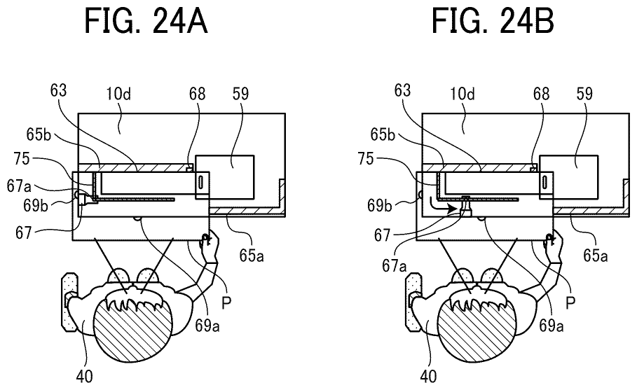

FIGS. 24A and 24B are diagrams each of which illustrates an operation of an inner finisher included in an image forming apparatus according to the fourth embodiment of the present disclosure.

Referring to FIGS. 23A, 23B, 24A and 24B, a description is given of the configuration of an inner finisher 10d of an image forming apparatus 1d according to the present embodiment.

FIG. 23A is a top view of the inner finisher 10d.

FIG. 23B is a front view of the inner finisher 10d.

As illustrated in FIGS. 23A and 23B, the inner finisher 10d (as an example of a post-processing apparatus) includes an entrance roller 51, a return roller 54, a tapping roller 55, a sheet ejection roller 56, a reference fence 58, a stapler 59, a sheet ejection tray 60, jogger fences 62, a staple slit 63, a start button 64, an exterior 65, a conveyance direction stopper 65a, a width direction stopper 65b, a microphone 67, a sheet bundle detection sensor 68 (first detector), a motion sensor 69a, a motion sensor 69b, a movement motor 73, a belt 74, and a guide 75. The configurations of these devices and units in the inner finisher 10d other than the microphone 67, the motion sensor 69a, the motion sensor 69b, the movement motor 73, the belt 74, and the guide 75 are the same as the configurations of the devices and units in the inner finisher 10a according to the second embodiment described above. The motion sensor 69a and the motion sensor 69b are examples of the “second detector” in the present disclosure.

The motion sensor 69a is a sensor that detects a motion of a person who is present on the front side of the inner finisher 10d. The motion sensor 69b is a sensor that detects a motion of a person who is present on the side face side of the inner finisher 10d. The motion sensor 69a and the motion sensor 69b are infrared sensors that detect infrared rays emitted by a person to detect the presence or absence of the person, ultrasonic sensors, camera sensors that detect the presence or absence of the person from, for example, a captured image.

The positions of the motion sensor 69a and the motion sensor 69b are not limited to the positions illustrated in FIGS. 23A and 23B. The motion sensor 69a and the motion sensor 69b may be arranged at any positions as long as the motion sensor 69a and the motion sensor 69b can detect a user. Further, the present disclosure is not limited to the arrangement of multiple motion sensors such as the motion sensor 69a and the motion sensor 69b. For example, when the motion sensor 69a alone is mounted on the inner finisher 10d and the user is detected by the motion sensor 69a, the microphone 67 may be moved such that the sound collection direction of the microphone 67 faces the front direction of the inner finisher 10d. On the other hand, when the motion sensor 69a alone is mounted on the inner finisher 10d and the user is not detected by the motion sensor 69a, the microphone 67 may be moved such that the sound collection direction of the microphone 67 faces the sheet ejection direction of the inner finisher 10d.

The movement motor 73 is a motor that moves the microphone 67 via the belt 74 along the guide 75 to change the sound collection direction of the microphone 67. The belt 74 is a belt stretched between the rotary shaft of the movement motor 73 and the rotary shaft 67a of the microphone 67. As illustrated in FIG. 23A, the guide 75 is a guide member that moves the rotary shaft 67a of the microphone 67 including a portion extending in a front-and-back direction and a portion extending in a left-and-right direction.

The rotary shaft 67a of the microphone 67 moves along the guide 75 by the driving and rotation of the movement motor 73 and rotates about the rotary shaft 67a, so as to change the sound collection direction. In FIG. 24A, the sound collection direction of the microphone 67 is not in the direction in which the user 40 is located. When the sheet bundle P is set in the staple slit 63 by the user 40 and the motion sensor 69a detects the user 40 in front of the inner finisher 10d, the microphone 67 moves along the guide 75 and rotates about the rotary shaft 67a to change the sound collection direction to the direction of the user 40, as illustrated in FIG. 24B. As a result, the microphone 67 can easily collect sound that is the voice of the user 40.

### Hardware Configuration of Image Forming Apparatus

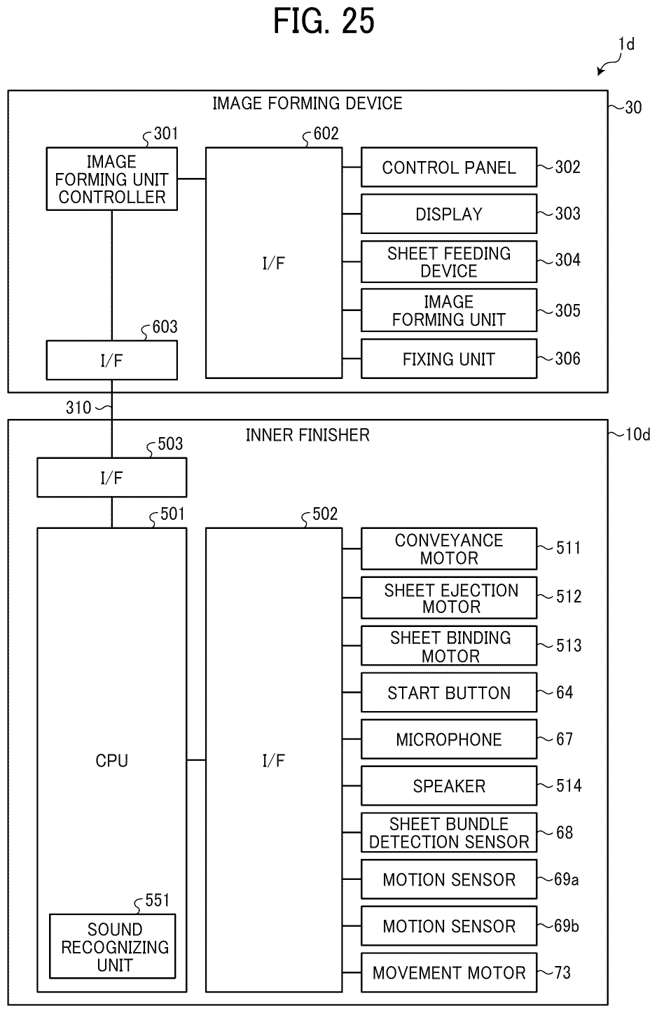

FIG. 25 is a block diagram illustrating an example of a hardware configuration of an image forming apparatus according to the fourth embodiment of the present disclosure.

Referring to FIG. 25, a description is given of a hardware configuration of the image forming apparatus 1d according to the present embodiment.

As illustrated in FIG. 25, the image forming apparatus 1d includes the inner finisher 10d and an image forming device 30. The configuration of the image forming device 30 of the image forming apparatus 1d is the same as the configuration in the image forming device 30 of the image forming apparatus 1 according to the first embodiment.

As illustrated in FIG. 25, the inner finisher 10d includes a central processing unit (CPU) 501, an interface (I/F) 502, an interface (I/F) 503, a conveyance motor 511, a sheet ejection motor 512, a sheet binding motor 513, a start button 64, a microphone 67, a speaker 514, a sheet bundle detection sensor 68 (first detector), a motion sensor 69a, a motion sensor 69b, and a movement motor 73. The configurations of these devices and units in the inner finisher 10d other than the motion sensor 69a, the motion sensor 69b, and the movement motor 73 are the same as the configurations of the devices and units in the inner finisher 10a according to the second embodiment. The motion sensor 69a and the motion sensor 69b are examples of the “second detector” in the present disclosure.

Detection signals detected by the motion sensor 69a and the motion sensor 69b are transmitted to the CPU 501 via the I/F 502. The CPU 501 controls the rotation of the movement motor 73 via the I/F 502.

### Flow of Manual Binding Process of Inner Finisher of Image Forming Apparatus

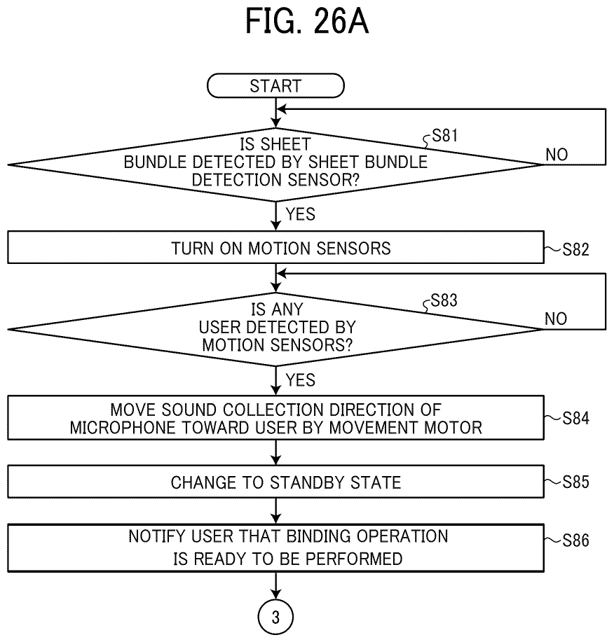

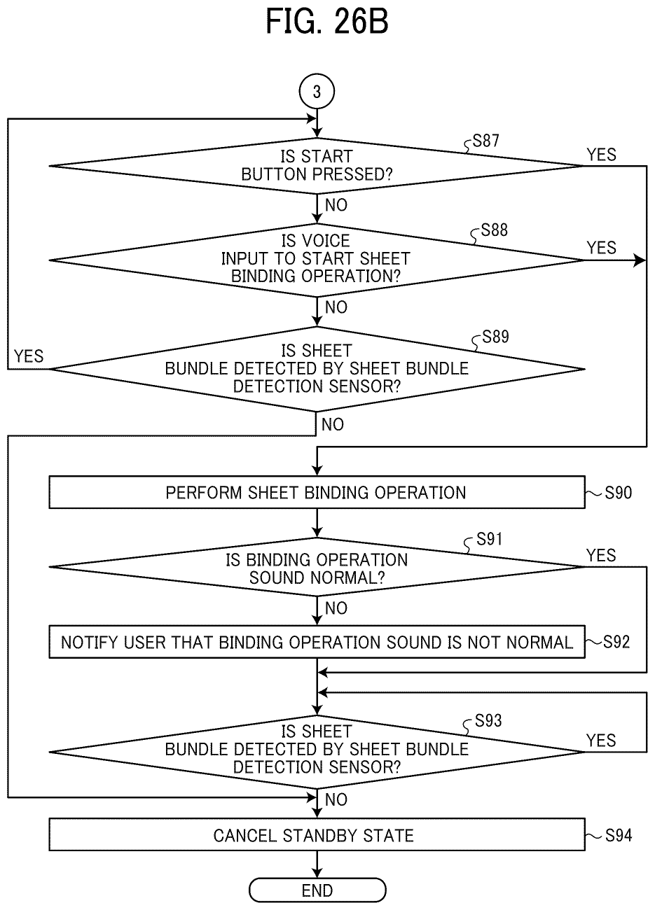

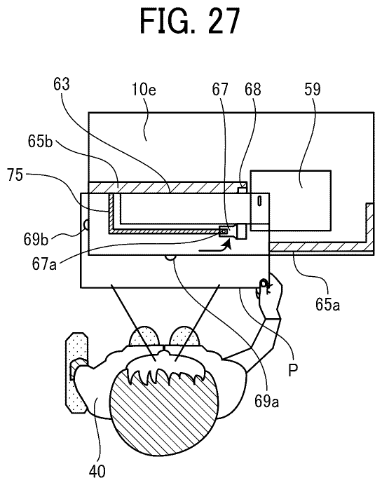

FIGS. 26A and 26B are separated drawings of a flowchart of an example of a process for executing a manual binding operation of an inner finisher included in an image forming apparatus according to the fourth embodiment of the present disclosure.

Referring to FIGS. 26A and 26B, a description is given of the flow of the manual binding operation performed by of the inner finisher 10d of the image forming apparatus 1d according to the present embodiment.

### Steps S81 to S83

The operations of steps S81 to S83 are the same as the operations of steps S41 to

S43, respectively, illustrated in FIG. 20 described above.

### Step S84

The CPU 501 causes the microphone 67 to move and rotate by the movement motor 73 along the guide 75 so that the sound collection direction of the microphone 67 is the direction of the user 40 detected by the motion sensor 69a or the motion sensor 69b. For example, when the user 40 is detected by the motion sensor 69a, the CPU 501 causes the microphone 67 to move and rotate so that the sound collection direction of the microphone 67 is the front direction. When the user 40 is detected by the motion sensor 69b, the CPU 501 causes the microphone 67 to move and rotate so that the sound collection direction of the microphone 67 is the side face direction, in other words, the detection direction of the motion sensor 69b. The process then proceeds to step S85.

### Steps S85 to S94

The operations of steps S85 to S94 are the same as the operations of steps S45 to S54, respectively, illustrated in FIG. 20 described above.

The operations of steps S81 to S94 described above are repeatedly executed.

As described above, in the inner finisher 10d of the image forming apparatus 1d according to the present embodiment, the motion sensor 69a and the motion sensor 69b detect the motion of a person (user) and the CPU 501 causes the microphone 67 to change the sound collection direction by the movement motor 73 according to the detected state by the motion sensor 69a and the motion sensor 69b. As a result, the microphone 67 can easily collect sound that is the voice of the user 40.

### Modification of Fourth Embodiment

A description is given of an image forming apparatus according to a modification of the fourth embodiment of the present disclosure, regarding the difference from the image forming apparatus 1d according to the fourth embodiment of the present disclosure.

In the present modification, a description is given of the operation of effectively collecting an operating sound in the sheet binding operation by the stapler 59. The overall configuration and hardware configuration of an image forming apparatus and configuration of an inner finisher are the same as those described in the fourth embodiment described above.

FIG. 27 is a diagram illustrating an operation of an inner finisher included in an image forming apparatus according to the modification of the fourth embodiment of the present disclosure.

Referring to FIGS. 27, a description is given of the configuration of an inner finisher 10e (as an example of a post-processing apparatus) of an image forming apparatus (an image forming apparatus 1e in this modification) according to the present modification.

In the present modification, as illustrated in FIG. 27, the microphone 67 rotates about the rotary shaft 67a, for example, at the end of the guide 75, immediately before the sheet binding operation by the stapler 59, so as to change the sound collection direction to the direction of the stapler 59. As a result, the microphone 67 can easily collect the operating sound of the sheet binding operation of the stapler 59.

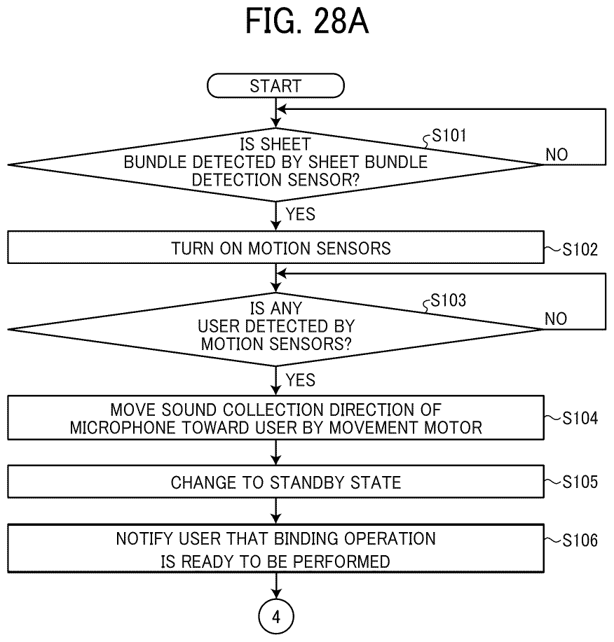

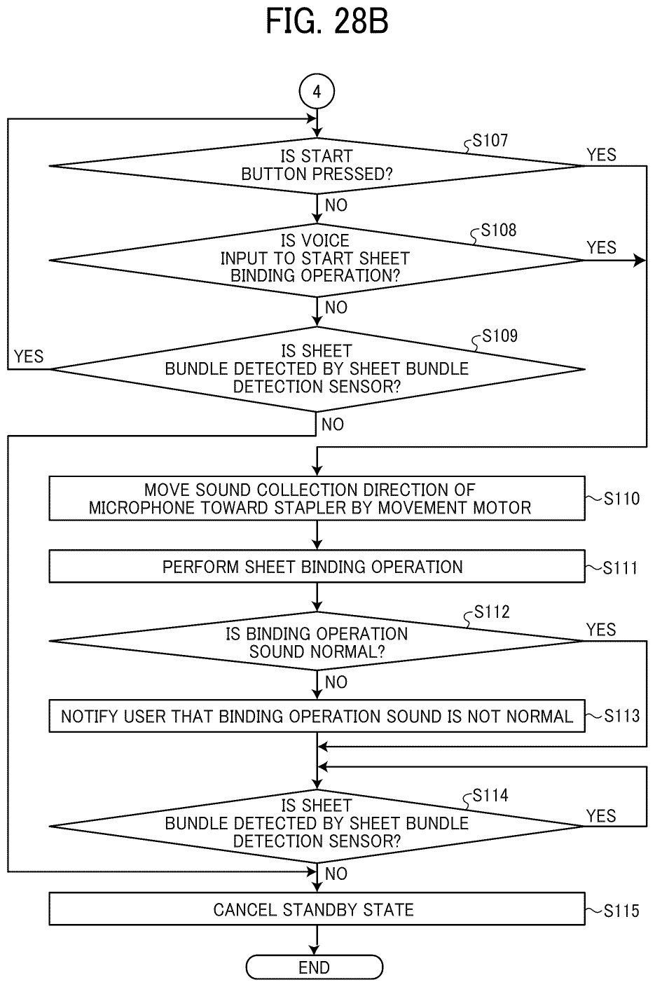

FIGS. 28A and 28B are separated diagrams of a flowchart of an example of a process for executing a manual binding operation of an inner finisher included in an image forming apparatus according to the modification of the fourth embodiment of the present disclosure.

Referring to FIGS. 28A and 28B, a description is given of the flow of the manual binding operation performed by the inner finisher 10e of the image forming apparatus 1e according to the present modification.

### Steps S101 to S109

The operations of steps S101 to S109 are the same as the operations of steps S81 to S89, respectively, illustrated in FIGS. 26A and 26B described above. In step S107, when the start button 64 is pressed (YES in step S107), the process proceeds to step S110. Further, in step S108, when a voice (sound) for starting the sheet binding operation is input to the microphone 67 (YES in step S108), the process proceeds to step S110.

### Step S110

The CPU 501 causes the microphone 67 to rotate about the rotary shaft 67a, for example, at the end of the guide 75, by the movement motor 73, so as to change the sound collection direction of the microphone 67 to the direction of the stapler 59. As a result, the microphone 67 can easily collect the operating sound of the sheet binding operation of the stapler 59, and the accuracy of the sound recognition by the sound recognition unit 551 can be enhanced. Then, the process then proceeds to step S111.

### Steps S111 to S115

The operations of steps S111 to S115 are the same as the operations of steps S90 to S94, respectively, illustrated in FIGS. 26A and 26B described above.

The operations of steps S101 to S115 described above are repeatedly executed.

As described above, in the inner finisher 10e of the image forming apparatus 1e according to the present modification, the CPU 501 causes the movement motor 73 to change the sound collection direction of the microphone 67 to the direction in which the stapler 59 is disposed, before the sheet binding operation is performed. As a result, the microphone 67 can easily collect the operating sound of the sheet binding operation of the stapler 59, and the accuracy of the sound recognition by the sound recognition unit 551 can be enhanced.

A description is given below of some aspects of the present disclosure.

### Aspect 1

In Aspect 1, a post-processing apparatus includes a binder, a sound collector, a determination unit, and a notification unit. The binder performs a sheet binding operation on a sheet bundle. The sound collector is a device to which an operating sound of the sheet binding operation by the binder is input. The determination unit determines whether the operating sound input by the sound collector is normal or not. The notification unit notifies a user that the sheet binding operation is abnormal when the determination unit determines that the operating sound is not normal.

### Aspect 2

In Aspect 2, in the post-processing apparatus according to Aspect 1, the determination unit discriminates a type of the operating sound when the operating sound is not normal, and the notification unit notifies the user of a content according to the type of the operating sound discriminated by the determination unit.

### Aspect 3

In Aspect 3, in the post-processing apparatus according to Aspect 2, the notification unit causes the display device to display a content for prompting removal of a staple from the binder when the determination unit determines that the operating sound is the sound of the sheet binding operation with no sheet bundle set properly.

### Aspect 4

In Aspect 4, in the post-processing apparatus according to Aspect 2, the notification unit causes the display device to display a content for prompting the user to perform the sheet binding operation on the sheet bundle with an appropriate number of sheets when the determination unit determines that the operating sound is the sound of the sheet binding operation that is performed in a case where the staple does not properly penetrate the sheet bundle.

### Aspect 5

In Aspect 5, the post-processing apparatus according to any one of Aspects 1 to 4 further includes a first detector and a controller. The first detector detects the sheet bundle set in the binder. The controller moves to a preparation state in which the binder can perform the sheet binding operation when the first detector detects the sheet bundle. The binder performs the sheet binding operation in the preparation state when a voice is input to the sound collector to start the sheet binding operation or when an operation unit for starting the sheet binding operation is operated.

### Aspect 6

In Aspect 6, in the post-processing apparatus according to Aspect 5, the controller cancels the preparation state when the first detector does not detect the sheet bundle in the preparation state or when the first detector does not detect the sheet bundle after the binder has performed the sheet binding operation.

### Aspect 7

In Aspect 7, in the post-processing apparatus according to Aspect 2 or 4, the binder cancels the binding state of the sheet bundle when the determination unit determines that the operating sound is a sound of the sheet binding operation when a staple does not penetrate the sheet bundle properly.

### Aspect 8

In Aspect 8, the post-processing apparatus according to any one of Aspect 1 to 4 further includes a second detector and a controller. The second detector detects a motion of a person. The controller changes the sound collection direction of the sound collector according to a detected state by the second detector.

### Aspect 9

In Aspect 9, in the post-processing apparatus according to Aspect 8, the controller changes the sound collection direction of the sound collector to a direction in which the binder is disposed, before the sheet binding operation is started.

### Aspect 10

In Aspect 10, an image forming apparatus includes an image forming device that forms an image on a sheet, and the post-processing apparatus according to any one of Aspects 1 to 9.

### Aspect 11

In Aspect 11, a post-processing apparatus includes a post-processing device, a sound collector, and circuitry. The post-processing device performs a post-processing operation on a sheet. The sound collector collects and inputs an operating sound of the post-processing operation performed by the post-processing device. The circuitry is to determine whether the operating sound input from the sound collector is normal or abnormal, output an error notification that the post-processing operation is abnormal when the operating sound is determined to be abnormal, and control the post-processing device to end the post-processing operation when the operating sound is determined to be normal.

### Aspect 12

In Aspect 12, the post-processing apparatus according to Aspect 11 further includes a sensor to detect the sheet set in the post-processing device. The circuitry is further to control the post-processing device to change to a standby state to perform the post-processing operation when the sensor detects the sheet in the post-processing device, control the post-processing device to perform the post-processing operation in response to an input of an instruction to start the post-processing operation, and control the post-processing device to cancel the standby state before ending the post-processing operation when the operating sound is determined to be normal.

### Aspect 13

In Aspect 13, in the post-processing apparatus according to Aspect 11, the circuitry is further to control the post-processing device to change to a standby state to perform the post-processing operation when the sound collector inputs sound indicating the post-processing operation or the sensor detects the sheet in the post-processing device, control the post-processing device to perform the post-processing operation in response to an input of an instruction to start the post-processing operation, and control the post-processing device to cancel the standby state before ending the post-processing operation when the operating sound is determined to be normal.

### Aspect 14

In Aspect 14, in the post-processing apparatus according to Aspect 11, the circuitry is further to determine a type of abnormality of the operating sound when the operating sound is determined to be abnormal, and display the type of abnormality of the operating sound determined on a display of an image forming apparatus.

### Aspect 15

In Aspect 15, in the post-processing apparatus according to Aspect 14, the type of abnormality of the operating sound includes the sheet not set properly in the post-processing apparatus. The circuitry is further to display, on the display, an instruction to remove a staple from the post-processing device when it is determined that the type of abnormality is determined to be the sheet not set properly in the post-processing apparatus.

### Aspect 16

In Aspect 16, in the post-processing apparatus according to Aspect 14, the post-processing device binds the sheet with a staple as the post-processing operation. The type of abnormality of the operating sound includes the staple not penetrating the sheet properly. The circuitry is further to display, on the display, an instruction to perform the post-processing operation on the sheet with an appropriate number of sheets when it is determined that the type of abnormality is determined to be the staple not penetrating the sheet properly.

### Aspect 17

In Aspect 17, the post-processing apparatus according to any one of Aspects 11 to 16 further includes the post-processing device binds the sheet with a staple as the post-processing operation. The type of abnormality of the operating sound includes the staple not penetrating the sheet properly. The circuitry is further to display, on the display, an instruction to cancel a binding operation on the sheet when it is determined that the type of abnormality is determined to be the staple not penetrating the sheet properly.

### Aspect 18

In Aspect 18, the post-processing apparatus according to Aspect 11 further includes a sensor to detect the sheet set in the post-processing device. The circuitry is further to change to a standby state in which the post-processing device performs the post-processing operation when the sensor detects the sheet, and cause the post-processing device to perform the post-processing operation in the standby state, when a sound is input to the sound collector to start the post-processing operation or when an operation unit is operated to start the post-processing operation.

### Aspect 19

In Aspect 19, in the post-processing apparatus according to Aspect 14 or 18, the circuitry is further to cancel the standby state when the sensor does not detect the sheet in the standby state or when the sensor does not detect the sheet after the post-processing device has performed the post-processing operation.

### Aspect 20

In Aspect 20, the post-processing apparatus according to any one of Aspects 11 to 16 further includes a sensor to detect a motion of a person. The circuitry is further to change a direction of collecting sound by the sound collector according to a condition of detection by the sensor.

### Aspect 21

In Aspect 21, in the post-processing apparatus according to Aspect 20, the circuitry is further configured to change the direction in which the sound collector collects the sound to a direction in which the post-processing device is located before the post-processing operation is started.

### Aspect 22

In Aspect 22, an image forming apparatus includes an image forming device to form an image on a sheet, and the post-processing apparatus according to any one of Aspects 11 to 21.

### Aspect 23

In Aspect 23, an image forming apparatus includes an image forming device, a post-processing apparatus, a sound collector, and circuitry. The image forming device forms an image on a sheet. The post-processing apparatus performs a post-processing operation on the sheet that has passed through the image forming device. The sound collector collects and inputs an operating sound of the post-processing operation performed by the post-processing apparatus. The circuitry is to determine whether the operating sound input by the sound collector is normal or abnormal, output an error notification that the post-processing operation is abnormal when the operating sound is determined to be abnormal, and control the post-processing device to end the post-processing operation when the operating sound is determined to be normal.

The present disclosure is not limited to specific embodiments described above, and numerous additional modifications and variations are possible in light of the teachings within the technical scope of the appended claims. It is therefore to be understood that the disclosure of this patent specification may be practiced otherwise by those skilled in the art than as specifically described herein, and such, modifications, alternatives are within the technical scope of the appended claims. Such modifications are also included in the technical scope of the present disclosure.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of this disclosure and are included in the scope of the invention recited in the claims and its equivalent.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. A post-processing apparatus comprising:
a post-processing device to perform a post-processing operation on a sheet;
a sound collector to collect and input an operating sound of the post-processing operation performed by the post-processing device; and
circuitry configured to:
determine whether the operating sound input from the sound collector is normal or abnormal;
output an error notification that the post-processing operation is abnormal when the operating sound is determined to be abnormal; and
control the post-processing device to end the post-processing operation when the operating sound is determined to be normal.

2. The post-processing apparatus according to claim 1, further comprising a sensor to detect the sheet set in the post-processing device,
wherein the circuitry is further configured to:
control the post-processing device to change to a standby state to perform the post-processing operation when the sensor detects the sheet in the post-processing device;
control the post-processing device to perform the post-processing operation in response to an input of an instruction to start the post-processing operation; and
control the post-processing device to cancel the standby state before ending the post-processing operation when the operating sound is determined to be normal.

3. The post-processing apparatus according to claim 1,
wherein the circuitry is further configured to:
control the post-processing device to change to a standby state to perform the post-processing operation when the sound collector inputs sound indicating the post-processing operation or the sensor detects the sheet in the post-processing device;
control the post-processing device to perform the post-processing operation in response to an input of an instruction to start the post-processing operation; and
control the post-processing device to cancel the standby state before ending the post-processing operation when the operating sound is determined to be normal.

4. The post-processing apparatus according to claim 1,
wherein the circuitry is further configured to:
determine a type of abnormality of the operating sound when the operating sound is determined to be abnormal; and
display the type of abnormality of the operating sound determined on a display of an image forming apparatus.

5. The post-processing apparatus according to claim 4,
wherein the type of abnormality of the operating sound includes the sheet not set properly in the post-processing apparatus, and
the circuitry is further configured to display, on the display, an instruction to remove a staple from the post-processing device when it is determined that the type of abnormality is determined to be the sheet not set properly in the post-processing apparatus.

6. The post-processing apparatus according to claim 4,
wherein the post-processing device binds the sheet with a staple as the post-processing operation,
the type of abnormality of the operating sound includes the staple not penetrating the sheet properly, and
the circuitry is further configured to display, on the display, an instruction to perform the post-processing operation on the sheet with an appropriate number of sheets when it is determined that the type of abnormality is determined to be the staple not penetrating the sheet properly.

7. The post-processing apparatus according to claim 4,
wherein the post-processing device binds the sheet with a staple as the post-processing operation,
the type of abnormality of the operating sound includes the staple not penetrating the sheet properly, and
the circuitry is further configured to display, on the display, an instruction to cancel a binding operation on the sheet when it is determined that the type of abnormality is determined to be the staple not penetrating the sheet properly.

8. The post-processing apparatus according to claim 1, further comprising a sensor to detect the sheet set in the post-processing device,
wherein the circuitry is further configured to:
change to a standby state in which the post-processing device performs the post-processing operation when the sensor detects the sheet; and
cause the post-processing device to perform the post-processing operation in the standby state,
when a sound is input to the sound collector to start the post-processing operation; or
when an operation unit is operated to start the post-processing operation.

9. The post-processing apparatus according to claim 8,
wherein the circuitry is further configured to cancel the standby state when the sensor does not detect the sheet in the standby state or when the sensor does not detect the sheet after the post-processing device has performed the post-processing operation.

10. The post-processing apparatus according to claim 1, further comprising a sensor to detect a motion of a person,
wherein the circuitry is further configured to change a direction of collecting sound by the sound collector according to a condition of detection by the sensor.

11. The post-processing apparatus according to claim 10,
wherein the circuitry is further configured to change the direction in which the sound collector collects the sound to a direction in which the post-processing device is located before the post-processing operation is started.

12. An image forming apparatus comprising:
an image forming device to form an image on a sheet; and
the post-processing apparatus according to claim 1.

13. An image forming apparatus comprising:
an image forming device to form an image on a sheet;
a post-processing apparatus to perform a post-processing operation on the sheet that has passed through the image forming device;
a sound collector to collect and input an operating sound of the post-processing operation performed by the post-processing apparatus; and
circuitry configured to:
determine whether the operating sound input by the sound collector is normal or abnormal;
output an error notification that the post-processing operation is abnormal when the operating sound is determined to be abnormal; and
control the post-processing device to end the post-processing operation when the operating sound is determined to be normal.
